(19) United States
(12) Patent Application Publication
(10) Pub. No.: US 2011/0128523 A1
(43) Pub. Date: Jun. 2, 2011

(54) STAGE APPARATUS, EXPOSURE APPARATUS, DRIVING METHOD, EXPOSING METHOD, AND DEVICE FABRICATING METHOD

(75) Inventor: Hiromitsu YOSHIMOTO, Saitama-shi (JP)

(73) Assignee: NIKON CORPORATION, TOKYO (JP)

(21) Appl. No.: 12/948,033

(22) Filed: Nov. 17, 2010

Related U.S. Application Data
(60) Provisional application No. 61/272,927, filed on Nov. 19, 2009.

(51) Int. Cl. G03B 27/62

(52) U.S. Cl. 355/75; 355/77

(57) ABSTRACT

A drive system drives the moving body based on: measurement results of a first measuring system that measures the position of the moving body within an plane by radiating a measurement beam from an arm member to a grating disposed in one surface of a moving body that is parallel to an XY plane; and measurement results of a second measuring system that uses laser interferometers to measure a change in the shape of the arm member. The drive system uses the measurement results of the second measuring system to correct measurement error, owing to a change in the shape of the arm member, included in the measurement results of the first measuring system.

### CROSS-REFERENCE TO RELATED APPLICATION

This application is a non-provisional application claiming priority to and the benefit of U.S. provisional application No. 61/272,927, filed on Nov. 19, 2009. The entire contents of which are incorporated herein by reference.

### BACKGROUND

The present invention relates to a stage apparatus, an exposure apparatus, a driving method, an exposing method, and a device fabricating method.

Conventionally, lithographic processes that fabricate electronic devices (i.e., microdevices), such as semiconductor devices (i.e., integrated circuits and the like) and liquid crystal display devices, principally use step-and-repeat type projection exposure apparatuses (i.e., so-called steppers), step-and-scan type projection exposure apparatuses (i.e., so-called scanning steppers or scanners), or the like.

In these types of exposure apparatuses, the position of a fine motion stage holding a substrate, such as a glass plate or a wafer whereon a pattern to be transferred is formed (hereinbelow, generically called a “wafer”), and moving two dimensionally is generally measured using laser interferometers. However, the increased fineness of patterns that attends the higher levels of integration of semiconductor devices in recent years has produced a demand for higher precision control of the position of the fine motion stage; therefore, ignoring short-term fluctuations in measurement values owing to air turbulence generated by the effects of a temperature gradient and/or by changes in the temperature of the atmosphere along the paths of the beams of the laser interferometers is no longer possible.

To correct such problems, various inventions have been proposed (e.g., refer to PCT International Publication No. WO2007/097379) related to exposure apparatuses that use an encoder, which has a measurement resolving power on the same order as or better than that of laser interferometers, as an apparatus for measuring the position of the fine motion stage. However, in the immersion exposure apparatus disclosed in PCT International Publication No. WO2007/097379 and the like, there is a risk that the wafer stage (i.e., a grating provided to an upper surface of the wafer stage) will deform because of the effects of heat of vaporization and the like when a liquid evaporates, and this problem has yet to be corrected.

To correct these problems, for example, a fifth embodiment in PCT International Publication No. WO2008/038752 discloses an exposure apparatus that comprises an encoder system wherein a grating is provided to the upper surface of a wafer stage, which comprises a light transmitting member, a measurement beam emerges from an encoder main body disposed below the wafer stage, and the measurement beam is caused to impinge the wafer stage, after which it is radiated to the grating; furthermore, the displacement of the wafer stage in the grating's directions of periodicity is measured by receiving the diffracted light generated by the grating. In this apparatus, the grating is covered by a cover glass and therefore tends not to be affected by heat of vaporization and the like, which enables the grating to measure the position of the wafer stage with high accuracy.

Nevertheless, in the exposure apparatus according to the fifth embodiment of PCT International Publication No. WO2008/038752, because the encoder main body is provided to a stage base plate, which is suspended from a projection optical system base plate via a hanging support member, there is a risk that the measurement accuracy of the encoder system will decline owing to, for example, the tilt of the optical axis of the encoder head caused by the transmission of vibrations to the stage base plate via the projection optical system base plate, the hanging support member, and the like when the exposure apparatus is performing an exposure.

### SUMMARY

A stage apparatus according to a first aspect of the present invention is a stage apparatus that comprises: a first moving body, which comprises guide members that extend in a first axial direction, that moves in a second axial direction, which are substantially orthogonal to the first axial direction; two second moving bodies, which are provided such that they are capable of moving independently in the first axial direction along the guide members, that move in the second axial direction together with the guide members by the movement of the first moving body; a holding member, which holds an object and is movably supported by the two second moving bodies within a two dimensional plane that includes at least the first axial direction and the second axial direction, whereon a measurement surface is disposed in a plane that is substantially parallel to the two dimensional plane; a first measuring system that comprises an arm member—which has a longitudinal direction oriented in the first axial direction, is disposed such that at least a first end part and a second end part opposes the measurement surface, and at least part of which is a solid part wherethrough light can travel—and that measures the position of the holding member at least within the two dimensional plane by radiating at least one first measurement beam from the arm member to the measurement surface and receiving the light of the first measurement beam from the measurement surface; a second measuring system, which comprises an optical interferometric measuring system that radiates at least one second measurement beam from the second end part of the arm member to a detection surface provided to the first end part of the arm member via the solid part and receives light of the second measurement beam from the detection surface, that measures a change in the shape of the arm member based on a measurement result of the optical interferometric measuring system; and a drive system, which drives the holding member based on the outputs of the first measuring system and the second measuring system.

An exposure apparatus of a second aspect of the present invention is an exposure apparatus that forms a pattern on an object by radiating an energy beam and comprises: a stage apparatus according to the present invention, wherein the object is mounted on the holding member; and a patterning apparatus, which radiates the energy beam to the object mounted on the holding member.

A device fabricating method according to a third aspect of the present invention is a device fabricating method that comprises the steps of: exposing an object using an exposure apparatus according to the present invention; and developing the exposed object.

A driving method according to a fourth aspect of the present invention is a driving method that moves a holding member, which holds an object, within a two dimensional plane that includes a first axial direction and a second axial direction orthogonal to the first axial direction, and comprises: a step that moves a first moving body, which comprises guide members that extend in the first axial direction, in the second axial direction; a step that moves two second moving bodies, which are provided such that they are capable of moving independently in the first axial direction along the guide members, in the second axial direction together with the guide members by the movement of the first moving body; a step that supports a holding member, which holds the object, with the two second moving bodies, synchronously moves the two moving bodies along the guide members, and moves the holding member in the first axial direction; a first measuring step that measures the position of the moving body at least within the two dimensional plane by radiating at least one first measurement beam from the arm member—which has a longitudinal direction oriented in the first axial direction, is disposed such that at least a first end part and a second end part opposes the measurement surface, and at least part of which is a solid part wherethrough light can travel—to the measurement surface disposed on the holding member along a surface that is substantially parallel to the two dimensional plane, and receiving the light of the first measurement beam from the measurement surface; a second measuring step that measures a change in the shape of the arm member by radiating at least one second measurement beam from the second end part of the arm member to a detection surface provided to the first end part of the arm member via the solid part and receiving light of the second measurement beam from the detection surface; and a step that drives the holding member based on the measurement results of the first measuring step and the second measuring step.

A first exposing method according to a fifth aspect of the present invention is an exposing method wherein a pattern is formed on an object by radiating an energy beam, and comprises: a process that uses a driving method of the present invention to drive in order to form the pattern.

A second exposing method according to a sixth aspect of the present invention is an exposing method that forms a pattern on an object by radiating an energy beam and comprises: a step that moves a first moving body, which comprises guide members that extend in the first axial direction, in the second axial direction; a step that moves two second moving bodies, wherein a space is formed and which are provided such that they are capable of moving independently in the first axial direction along the guide members, in the second axial direction together with the guide members by the movement of the first moving body; a mounting process that mounts the object to a holding member, which is held such that is capable of moving relative to the two moving bodies at least within a plane that is parallel to the two dimensional plane and wherein a measurement surface is provided to one surface that is substantially parallel to the two dimensional surface; a first measuring step that measures the position of the moving body at least within the two dimensional plane by radiating at least one first measurement beam from the arm member—which has a longitudinal direction oriented in the first axial direction, is disposed such that at least a first end part and a second end part opposes the measurement surface, and at least part of which is a solid part wherethrough light can travel—to the measurement surface disposed on the holding member along a surface that is substantially parallel to the two dimensional plane, and receiving the light of the first measurement beam from the measurement surface; a second measuring step that measures a change in the shape of the arm member by radiating at least one second measurement beam from the second end part of the arm member to a detection surface provided to the first end part of the arm member via the solid part and receiving light of the second measurement beam from the detection surface; and a scanning step that scans the object with respect to the energy beam by driving the holding member in a scanning direction within the two dimensional plane based on the measurement results of the first measuring step and the second measuring step.

A device fabricating method according to a seventh aspect of the present invention is a device fabricating method that comprises the steps of: exposing an object using an exposing method according to according to any one aspect of the first and second aspects of the present invention; and developing the exposed object.

### BRIEF DESCRIPTION OF THE DRAWINGS

FIG. 1 schematically shows the configuration of an exposure apparatus of one embodiment.

FIG. 2 is a schematic oblique view of a stage apparatus provided by the exposure apparatus shown in FIG. 1.

FIG. 3 is an exploded oblique view of the stage apparatus shown in FIG. 2.

FIG. 4A is a side view, viewed from the −Y direction, that shows the stage apparatus provided by the exposure apparatus shown in FIG. 1.

FIG. 4B is a plan view that shows the stage apparatus.

FIG. 5 is a block diagram that shows the configuration of a control system of the exposure apparatus shown in FIG. 1.

FIG. 6 is a plan view that shows the arrangement of magnet units and a coil unit that constitute a fine motion stage drive system.

FIG. 7A is a side view, viewed from the −Y direction, that shows the arrangement of the magnet units and the coil unit that constitute the fine motion stage drive system.

FIG. 7B is a side view, viewed from the +X direction, that shows the arrangement of the magnet units and the coil unit that constitute the fine motion stage drive system.

FIG. 8A is a view for explaining the operation performed when a fine motion stage is rotated around the Z axis with respect to coarse motion stages.

FIG. 8B is a view for explaining the operation performed when the fine motion stage is rotated around the Y axis with respect to the coarse motion stages.

FIG. 8C is a view for explaining the operation performed when the fine motion stage is rotated around the X axis with respect to the coarse motion stages.

FIG. 9 is a view for explaining the operation performed when a center part of the fine motion stage is flexed in the +Z direction.

FIG. 10A is an oblique view that shows a tip part of a measuring arm.

FIG. 10B is a plan view, viewed from the +Z direction, of the upper surface of the tip part of the measuring arm.

FIG. 11A is a block diagram of an X head.

FIG. 11B is for explaining the arrangement of the X head and Y head inside the measuring arm.

FIG. 12A is a view for explaining the case wherein the tip part of the measuring arm moves vertically (i.e., vibrates longitudinally) in the Z axial directions (i.e., the vertical directions).

FIG. 12B is a view for explaining the case wherein the tip part of the measuring arm moves vertically (i.e., vibrates longitudinally) in the Z axial directions (i.e., the vertical directions).

FIG. 13 is a view for explaining four laser interferometers that constitute a measuring system for measuring the surface position of a tip surface of the measuring arm.

FIG. 14 is a view for explaining encoders that constitute the measuring system for measuring the displacement of the tip surface of the measuring arm.

FIG. 15A is a view for explaining a method of generating correction information of the encoder system corresponding to the surface position of the tip surface of the measuring arm.

FIG. 15B is a graph that corresponds to the generated correction information.

FIG. 16A is a view for explaining a method of driving a wafer during a scanning exposure.

FIG. 16B is for explaining a method of driving the wafer during stepping.

FIG. 17 shows the arrangement of a grating according to a modified example.

FIG. 18 is a schematic oblique view of a stage apparatus that has two stage units.

FIG. 19 is a flow chart that depicts one example of a process of fabricating a microdevice of the present invention.

FIG. 20 depicts one example of the detailed process of step S13 described in FIG. 19.

### DESCRIPTION OF EMBODIMENTS

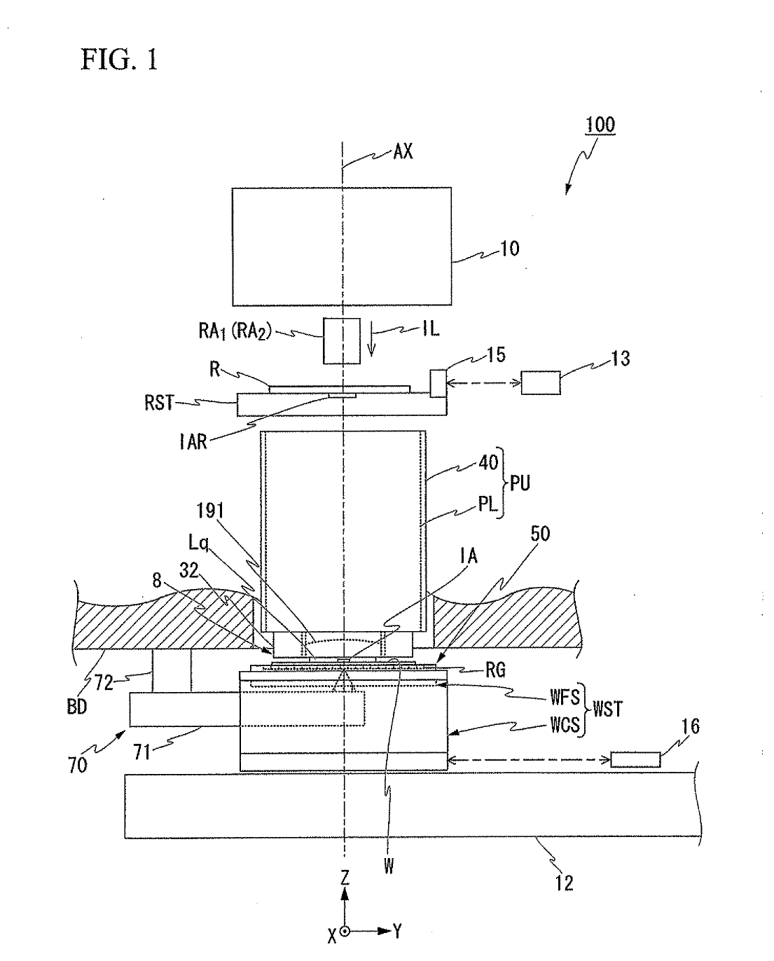

The text below explains one embodiment of the present invention, referencing FIG. 1 through FIG. 16B.

FIG. 1 schematically shows the configuration of an exposure apparatus 100 according to one embodiment. The exposure apparatus 100 is a step-and-scan-type projection exposure apparatus, namely, a so-called scanner. In the present embodiment as discussed below, a projection optical system PL is provided; furthermore, in the explanation below, the directions parallel to an optical axis AX of the projection optical system PL are the Z axial directions, the directions within a plane that is orthogonal thereto and wherein a reticle and a wafer are scanned relative to one another are the Y axial directions, the directions that are orthogonal to the Z axis and the Y axis are the X axial directions, and the rotational (i.e., tilt) directions around the X axis, the Y axis, and the Z axis are the θx, the θy, and the θz directions, respectively.

As shown in FIG. 1, the exposure apparatus 100 comprises an illumination system 10, a reticle stage RST, a projection unit PU, a local liquid immersion apparatus 8, a stage apparatus 50 that has a fine motion stage WFS, and a control system that controls these elements. In FIG. 1, a wafer W is mounted on the fine motion stage WFS.

As disclosed in, for example, U.S. Patent Application Publication No. 2003/0025890, the illumination system 10 comprises a light source and an illumination optical system that comprises: a luminous flux intensity uniformizing optical system, which includes an optical integrator and the like; and a reticle blind (none of which are shown). The illumination system 10 illuminates, with illumination light IL (i.e., exposure light) at a substantially uniform luminous flux intensity, a slit shaped illumination area JAR, which is defined by a reticle blind (also called a masking system), on a reticle R. Here, as one example, ArF excimer laser light (with a wavelength of 193 nm) is used as the illumination light IL.

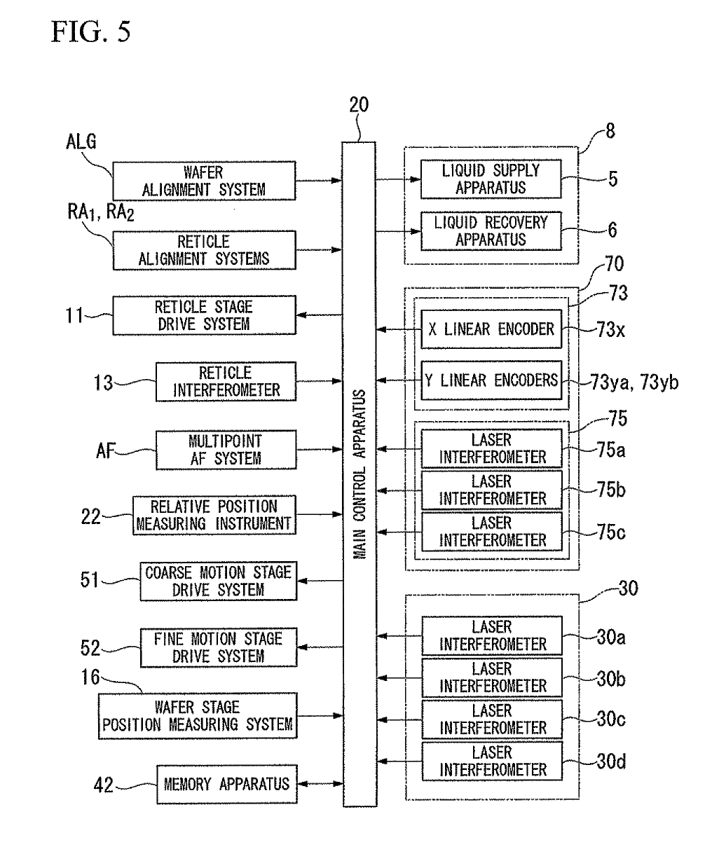

The reticle R, whose patterned surface (i.e., in FIG. 1, a lower surface) has a circuit pattern and the like formed thereon, is fixed onto the reticle stage RST by, for example, vacuum chucking. A reticle stage drive system 11 (not shown in FIG. 1; refer to FIG. 5) that comprises, for example, linear motors is capable of driving the reticle stage RST finely within an XY plane and at a prescribed scanning speed in scanning directions (i.e., in the Y axial directions, which are the lateral directions within the paper plane of FIG. 1).

The position of the reticle stage RST within the XY plane (including the rotational position about the θz axis) is continuously detected, with a resolving power of, for example, approximately 0.25 nm, by a reticle laser interferometer 13 (hereinafter, called a “reticle interferometer”), via a movable mirror 15 (actually, a Y movable mirror (or a retroflector) that has a reflective surface orthogonal to the Y axial directions and an X movable mirror that has a reflective surface orthogonal to the X axial directions are provided), which is fixed to the reticle stage RST. Measurement values of the reticle interferometer 13 are sent to a main control apparatus 20 (not shown in FIG. 1; refer to FIG. 5).

The projection unit PU is disposed below the reticle stage RST in FIG. 1. The projection unit PU comprises a lens barrel 40 and the projection optical system PL, which is held inside the lens barrel 40. A dioptric system, for example, that comprises a plurality of optical elements (i.e., lens elements) arrayed along the optical axis AX, which is parallel to the Z axial directions, is used as the projection optical system PL. The projection optical system PL is, for example, double telecentric and has a prescribed projection magnification (e.g., ¼×, ⅕×, or ⅛×). Consequently, when the illumination light IL that emerges from the illumination system 10 illuminates the illumination area IAR on the reticle R, the illumination light IL that passes through the reticle R, whose patterned surface is disposed substantially coincident with a first plane (i.e., the object plane) of the projection optical system PL, travels through the projection optical system PL (i.e., the projection unit PU) and forms a reduced image of a circuit pattern of the reticle R that lies within that illumination area JAR (i.e., a reduced image of part of the circuit pattern) on the wafer W, which is disposed on a second plane side (i.e., the image plane side) of the projection optical system PL and whose front surface is coated with a resist (i.e., a sensitive agent), in an area IA (hereinbelow, also called an “exposure area”) that is conjugate with the illumination area IAR. Furthermore, by synchronously scanning the reticle stage RST and the fine motion stage WFS, the reticle R is moved relative to the illumination area IAR (i.e., the illumination light IL) in one of the scanning directions (i.e., one of the Y axial directions) and the wafer W is moved relative to the exposure area IA (i.e., the illumination light IL) in the other scanning direction (i.e., the other Y axial direction); thereby, a single shot region (i.e., block area) on the wafer W undergoes a scanning exposure and the pattern of the reticle R is transferred to that shot region. Namely, in the present embodiment, the pattern is created on the wafer W by the illumination system 10, the reticle R, and the projection optical system PL, and that pattern is formed on the wafer W by exposing a photosensitive (i.e., resist) layer on the wafer W with the illumination light IL.

The local liquid immersion apparatus 8 is provided to enable the exposure apparatus 100 of the present embodiment to perform immersion exposures. The local liquid immersion apparatus 8 comprises a liquid supply apparatus 5 and a liquid recovery apparatus 6 (both of which are not shown in FIG. 1; refer to FIG. 5) as well as a nozzle unit 32. As shown in FIG. 1, the nozzle unit 32 is suspended from a main frame BD, which supports the projection unit PU and the like, via a support member (not shown) such that the nozzle unit 32 surrounds a lower end part of the lens barrel 40 that holds the optical element—of the optical elements that constitute the projection optical system PL—that is most on the image plane side (i.e., the wafer W side), here, a lens 191 (hereinbelow, also called a “tip lens”). In the present embodiment, the main control apparatus 20 controls both the liquid supply apparatus 5 (refer to FIG. 5), which via the nozzle unit 32 supplies a liquid to the space between the tip lens 191 and the wafer W, and the liquid recovery apparatus 6 (refer to FIG. 5), which via the nozzle unit 32 recovers the liquid from the space between the tip lens 191 and the wafer W. At this time, the main control apparatus 20 controls the liquid supply apparatus 5 and the liquid recovery apparatus 6 such that the amount of the liquid supplied and the amount of the liquid recovered are always equal. Accordingly, a fixed amount of a liquid Lq (refer to FIG. 1) is always being replaced and held between the tip lens 191 and the wafer W. In the present embodiment, it is understood that pure water, through which ArF excimer laser light (i.e., light with a wavelength of 193 nm) transmits, is used as the abovementioned liquid Lq. Furthermore, the refractive index n of pure water with respect to ArF excimer laser light is substantially 1.44, and the wavelength of the illumination light IL in pure water is therefore shortened to approximately 134 nm (i.e., 193 nm×1/n).

As shown in FIG. 1, the stage apparatus 50 comprises: a base plate 12, which is supported substantially horizontally by a vibration isolating mechanism (not illustrated) on a floor surface; a wafer stage WST, which holds the wafer W and moves on the base plate 12; and various measuring systems (16, 70) (refer to FIG. 5).

The base plate 12 comprises a member whose outer shape is shaped as a flat plate and whose upper surface is finished to an extremely high degree of flatness and serves as a guide surface when the wafer stage WST is moved.

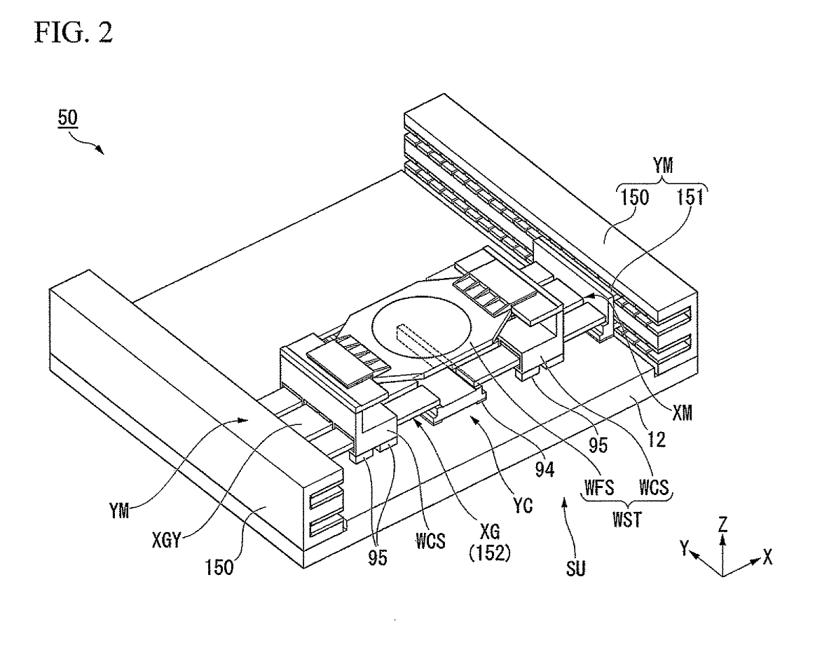

As shown in FIG. 2, the stage apparatus 50 comprises: a Y coarse motion stage YC (i.e., a first moving body), which moves by the drive of Y motors YM; two X coarse motion stages WCS (i.e., second moving bodies), which move independently by the drive of X motors XM; and the fine motion stage WFS (i.e., the holding member) which holds the wafer W and is moveably supported by the X coarse motion stages WCS. The Y coarse motion stage YC and the X coarse motion stages WCS constitute a stage unit SU. In addition, the Y motors YM and the X motors XM collectively constitute a coarse motion stage drive system 51 (refer to FIG. 5).

The pair of X coarse motion stages WCS and the fine motion stage WFS constitute the wafer stage WST discussed above. The fine motion stage WFS is driven by a fine motion stage drive system 52 (refer to FIG. 5) in the X, Y, Z, θx, θy, and θz directions, which correspond to six degrees of freedom, with respect to the X coarse motion stages WCS. In the present embodiment, the coarse motion stage drive system 51 and the fine motion stage drive system 52 constitute a wafer stage drive system 53.

The wafer stage position measuring system 16 (not shown in FIG. 2; refer to FIG. 1 and FIG. 5) measures the position within the XY plane (including the rotation in the θz directions) of the wafer stage WST (i.e., the X coarse motion stages WCS). In addition, the fine motion stage position measuring system 70 measures the position of the fine motion stage WFS, which the coarse motion stages WCS support, in the directions corresponding to six degrees of freedom (i.e., the X, Y, Z, θx, θy, and θz directions). The measurement results of the wafer stage position measuring system 16 and the fine motion stage position measuring system 70 are supplied to the main control apparatus 20 (refer to FIG. 5), which uses these measurement results to control the positions of the X coarse motion stages WCS and the fine motion stage WFS.

When the fine motion stage WFS is supported by the X coarse motion stages WCS, a relative position measuring instrument 22 (refer to FIG. 5), which is provided between the X coarse motion stages WCS and the fine motion stage WFS, can measure the relative position of the fine motion stage WFS and the coarse motion stages WCS in the X, Y, and θz directions, which correspond to three degrees of freedom.

It is possible to use as the relative position measuring instrument 22, for example, an encoder wherein a grating provided to the fine motion stage WFS serves as a measurement target, the X coarse motion stages WCS are each provided with at least two heads, and the position of the fine motion stage WFS in the X axial, Y axial, and θz directions is measured based on the outputs of these heads. The measurement results of the relative position measuring instrument 22 are supplied to the main control apparatus 20 (refer to FIG. 5).

The configuration and the like of the wafer stage position measuring system 16, the fine motion stage position measuring system 70, and each part of the stage apparatus 50 will be discussed in detail later.

In the exposure apparatus 100, a wafer alignment system ALG (not shown in FIG. 1; refer to FIG. 5) is disposed at a position at which it is spaced apart by a prescribed distance from the center of the projection unit PU on the +Y side thereof. For example, an image processing type field image alignment (FIA) system is used as the alignment system ALG. When a wafer alignment (e.g., an enhanced global alignment (EGA)) is performed, the main control apparatus 20 uses the wafer alignment system ALG to detect a second fiducial mark, which is formed in a measuring plate on the fine motion stage WFS (discussed later), or an alignment mark on the wafer W. The captured image signal output by the wafer alignment system ALG is supplied to the main control apparatus 20 via a signal processing system (not shown). During the alignment of the target mark, the main control apparatus 20 calculates the X and Y coordinates in a coordinate system based on the results of the detection of the wafer alignment system ALG (i.e., the results of the captured image) and the position of the fine motion stage WFS (i.e., the wafer W) during the detection.

In addition, in the exposure apparatus 100 of the present embodiment, an oblique incidence type multipoint focus position detection system AF (hereinbelow, abbreviated as “multipoint AF system”; not shown in FIG. 1; refer to FIG. 5), which is configured identically to the one disclosed in, for example, U.S. Pat. No. 5,448,332, is provided in the vicinity of the projection unit PU. The detection signal of the multipoint AF system AF is supplied to the main control apparatus 20 (refer to FIG. 5) via an AF signal processing system (not shown). The main control apparatus 20 detects, based on the detection signal output by the multipoint AF system AF, the position of the front surface of the wafer W in the Z axial directions at each detection point of a plurality of detection points of the multipoint AF system AF (i.e., the surface position information) and, based on the results of that detection, performs a so-called focus and leveling control on the wafer W during the scanning exposure. Furthermore, the multipoint AF system may be provided in the vicinity of the wafer alignment system ALG, the surface position information (i.e., nonuniformity information) of the front surface of the wafer W during wafer alignment (EGA) may be acquired beforehand, and the so-called focus and leveling control may be performed on the wafer W during an exposure using the surface position information and a measurement value of a laser interferometer system 75 (refer to FIG. 5), which constitutes part of the fine motion stage position measuring system 70 (discussed below).

In addition, a pair of image processing type reticle alignment systems RA₁, RA₂ (in FIG. 1, the reticle alignment system RA₂ is hidden on the paper plane far side of the reticle alignment system RA₁), each of which comprises an image capturing device, such as a CCD, and uses light (in the present embodiment, the illumination light IL) of the exposure wavelength as the illumination light for alignment, is disposed above the reticle stage RST, as disclosed in detail in, for example, U.S. Pat. No. 5,646,413. In a state wherein a measuring plate (discussed below) is positioned on the fine motion stage WFS directly below the projection optical system PL, the main control apparatus 20 uses the pair of reticle alignment systems RA₁, RA₂ to detect, through the projection optical system PL, a pair of first fiducial marks on the measuring plate corresponding to a projected image of a pair of reticle alignment marks (not illustrated) formed on the reticle R; thereby, the positional relationship between the center of the projection area of the pattern of the reticle R formed by the projection optical system PL and the reference positions on the measuring plate, namely, the centers of the two first fiducial marks, is detected. The detection signals of the reticle alignment systems RA₁, RA₂ are supplied to the main control apparatus 20 (refer to FIG. 5) via a signal processing system (not shown).

FIG. 5 shows the principal components of the control system of the exposure apparatus 100. The heart of the control system is the main control apparatus 20. The main control apparatus 20 is, for example, a workstation (or a microcomputer) that supervisorally controls each constituent part of the exposure apparatus 100 such as the local liquid immersion apparatus 8, the coarse motion stage drive system 51, and the fine motion stage drive system 52, all of which are discussed above.

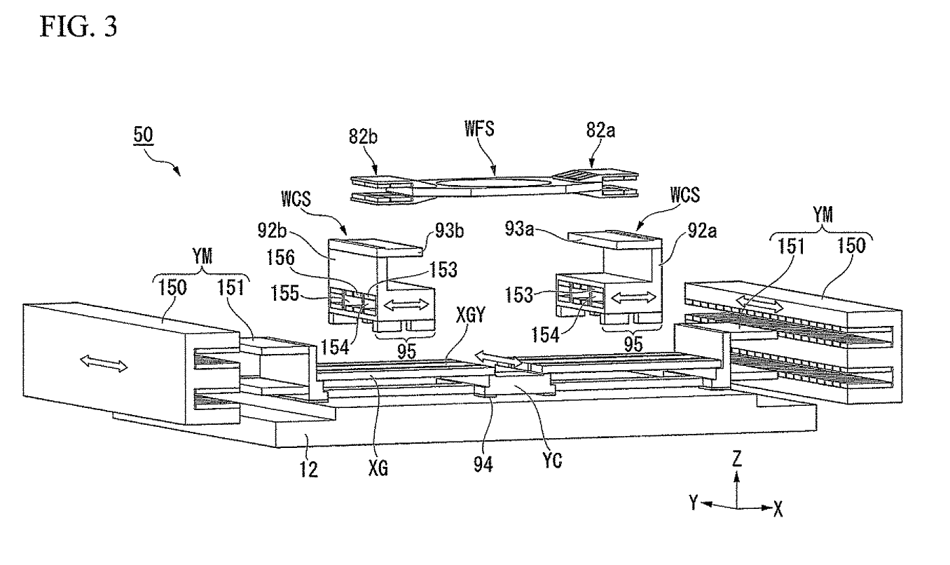

Continuing, the configuration and the like of each part of the stage apparatus 50 will now be discussed in detail, referencing FIG. 2 and FIG. 3.

The Y motors YM comprise stators 150, which are provided on both side ends of the base plate 12 in the X directions such that they extend in the Y directions, and sliders 151, which are provided on both ends of the Y coarse motion stage YC in the X directions. The stators 150 comprise permanent magnets, which are arrayed in the Y directions, and the sliders 151 comprise coils, which are arrayed in the Y directions. Namely, the Y motors YM are moving coil type linear motors that drive both the wafer stage WST and the Y coarse motion stage YC in the Y directions. Furthermore, while the above text explains an exemplary case of moving coil type linear motors, the linear motors may be moving magnet type linear motors.

In addition, aerostatic bearings (not shown), for example, air bearings, which are provided to the lower surfaces of the stators 150, levitationally support the stators 150 above the base plate 12 with a prescribed clearance. Thereby, the reaction force generated by the movement of the wafer stage WST, the Y coarse motion stage YC, and the like in either one of the Y directions moves the stators 150, which serve as Y countermasses in the Y directions, in the other Y direction and is thereby offset by the law of conservation of momentum.

The Y coarse motion stage YC comprises X guides XG (i.e., guide members), which are provided between the sliders 151, 151 and extend in the X directions, and is levitationally supported above the base plate 12 by a plurality of noncontact bearings, for example, air bearings 94, that is provided to a bottom surface of the Y coarse motion stage YC.

The X guides XG are provided with stators 152, which constitute the X motors XM. As shown in FIG. 3, sliders 153 of the X motors XM are provided with through holes 154, wherethrough the X guides XG are inserted, that pass through the X coarse motion stages WCS in the X directions.

The two X coarse motion stages WCS are each levitationally supported above the base plate 12 by a plurality of noncontact bearings, for example, air bearings 95, provided to the bottom surfaces of the X coarse motion stages WCS and move in the X directions independently of one another along the X guides XG by the drive of the X motors XM. The Y coarse motion stage YC is provided with, in addition to the X guides XG, X guides XGY whereto the stators of the Y linear motors that drive the X coarse motion stages WCS in the Y directions are provided. Furthermore, in each of the X coarse motion stages WCS, a slider 156 of the Y linear motor is provided in a through hole 155 (refer to FIG. 3), which passes through the X coarse motion stages WCS in the X directions. Furthermore, a configuration may be adopted wherein the X coarse motion stages WCS are supported in the Y directions by providing air bearings instead of providing the Y linear motors.

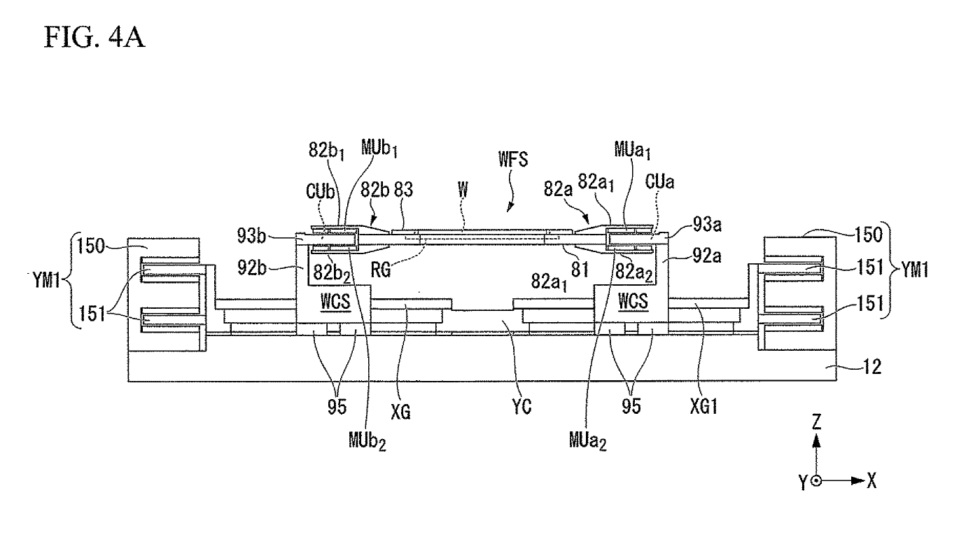

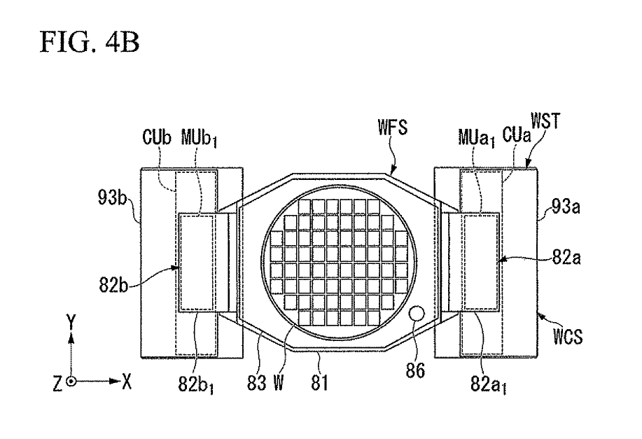

FIG. 4A is a side view, viewed from the −Y direction, of the stage apparatus 50, and FIG. 48 is a plan view of the stage apparatus 50. As shown in FIG. 4A and FIG. 4B, a pair of sidewall parts 92a, 92b and a pair of stator parts 93a, 93b, which are fixed to the upper surfaces of the sidewall parts 92a, 92b, are provided to the outer side end parts in the X directions of the X coarse motion stages WCS. As a whole, each of the coarse motion stages WCS has a box shape with a small height and that is open at the center part of the upper surface in the X axial directions and both side surfaces in the Y axial directions. Namely, a space is formed in each of the coarse motion stages WCS such that the space passes through the inner part of the coarse motion stages WCS in the Y axial directions.

Each of the stator parts 93a, 93b is a member whose outer shape is shaped as a plate; furthermore, the stator parts 93a, 93b respectively house coil units CUa, CUb, which are for driving the fine motion stage WFS. The main control apparatus 20 controls the size and direction of each electric current supplied to the coils that constitute the coil units CUa, CUb. The configuration of the coil units CUa, CUb will be further discussed below.

The +X side end part of the stator part 93a is fixed to the upper surface of the sidewall part 92a, and the −X side end part of the stator part 93b is fixed to the upper surface of the sidewall part 92b.

As shown in FIG. 4A and FIG. 4B, the fine motion stage WFS comprises a main body part 81, which consists of an octagonal plate shaped member whose longitudinal directions are oriented in the X axial directions in a plan view, and two slider parts 82a, 82b, which are fixed to one end part and the other end part of the main body part 81 in the longitudinal directions.

Because an encoder system measurement beam (i.e., laser light), which is discussed below, must be able to travel through the inner part of the main body part 81, the main body part 81 is formed from a transparent raw material wherethrough light can transmit. In addition, to reduce the effects of air turbulence on the laser light that passes through the inner part of the main body part 81, the main body part 81 is formed as a solid block (i.e., its interior has no space). Furthermore, the transparent raw material preferably has a low coefficient of thermal expansion; in the present embodiment, as one example, synthetic quartz (i.e., glass) is used. Furthermore, although the entire main body part 81 may be formed from the transparent material, a configuration may be adopted wherein only the portion wherethrough the measurement beam of the encoder system transmits is formed from the transparent raw material; furthermore, a configuration may be adopted wherein only the latter is formed as a solid.

A wafer holder (not shown), which holds the wafer W by vacuum chucking or the like, is provided at the center of the upper surface of the main body part 81 of the fine motion stage WFS. Furthermore, the wafer holder may be formed integrally with the fine motion stage WFS and may be fixed to the main body part 81 by bonding and the like or via, for example, an electrostatic chuck mechanism or a clamp mechanism.

Furthermore, as shown in FIG. 4A and FIG. 4B, a circular opening whose circumference is larger than the wafer W (i.e., the wafer holder) is formed in the center of the upper surface of the main body part 81 on the outer side of the wafer holder (i.e., the mounting area of the wafer W), and a plate 83 (i.e., a liquid repellent plate), whose octagonal outer shape (i.e., contour) corresponds to the main body part 81, is attached to the upper surface of the main body part 81. The front surface of the plate 83 is given liquid repellency treatment (i.e., a liquid repellent surface is formed) such that it is liquid repellent with respect to the liquid Lq. The plate 83 is fixed to the upper surface of the main body part 81 such that the entire front surface (or part of the front surface) of the plate 83 is coplanar with the front surface of the wafer W. In addition, as shown in FIG. 4B, a circular notch is formed in the vicinity of the +X side of the −Y side end part of the plate 83, and a measuring plate 86 is embedded in that notch in the state wherein the front surface of the measuring plate 86 is substantially coplanar with the front surface of the plate 83, namely, the front surface of the wafer W. At least a pair of the first fiducial marks, which are detected by the reticle alignment detection systems RA₁, RA₂ discussed above, and the second fiducial mark, which is detected by the wafer alignment system ALG, are formed in the front surface of the measuring plate 86 (note that none of the first and second fiducial marks are shown).

As shown in FIG. 4A, a two-dimensional grating RG (hereinbelow, simply called a “grating”) is disposed horizontally (i.e., parallel to the front surface of the wafer W) on the upper surface of the main body part 81 in an area whose circumference is larger than the wafer W. The grating RG comprises a reflective diffraction grating whose directions of periodicity are oriented in the X axial directions (i.e., an X diffraction grating) and a reflective diffraction grating whose directions of periodicity are oriented in the Y axial directions (i.e., a Y diffraction grating).

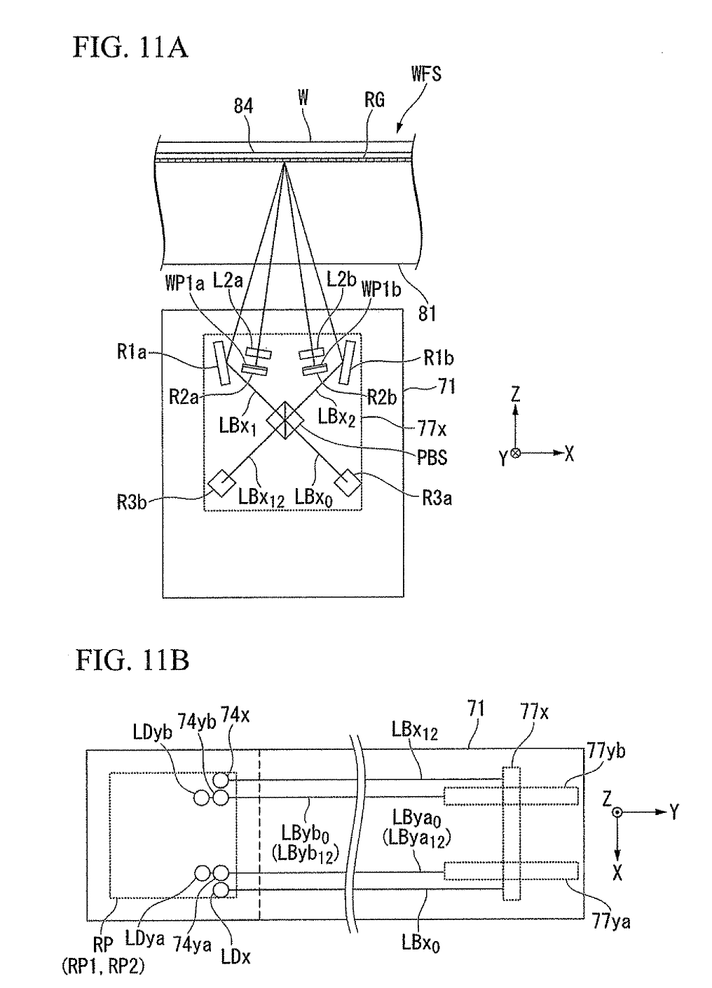

The upper surface of the grating RG is covered and protected by a protective member, for example, a cover glass 84 (not shown in FIG. 4A, refer to FIG. 11A). In the present embodiment, the electrostatic chucking mechanism (discussed above), which chucks the wafer holder, is provided to the upper surface of the cover glass 84. Furthermore, in the present embodiment, the cover glass 84 is provided such that it covers substantially the entire surface of the upper surface of the main body part 81, but the cover glass 84 may be provided such that it covers only the part of the upper surface of the main body part 81 that includes the grating RG. In addition, the protective member (i.e., the cover glass 84) may be formed from the same raw material as that of the main body part 81, but the present invention is not limited thereto; for example, the protective member may be formed from, for example, a metal or a ceramic material, or a configuration may be adopted wherein the protective member is formed as a thin film or the like.

As can be understood also from FIG. 4A, the main body part 81 is, as a whole, an octagonal plate shaped member wherein overhanging parts that protrude toward the outer side from the lower and upper end part of the one end part and the other end part in the longitudinal directions are formed, and a recessed part is formed in the bottom surface of the main body part 81 at the portion that opposes the grating RG. The center area of the main body part 81 at which the grating RG is disposed is formed as a plate with a substantially uniform thickness.

As shown in FIG. 4A and FIG. 4B, the slider part 82a comprises two plate shaped members 82a₁, 82a₂, which are rectangular in a plan view and whose size in the Y axial directions (i.e., length) and size in the X axial directions (i.e., width) are both smaller (by about one half) than those of the stator part 93a. The plate shaped members 82a₁, 82a₂ are fixed to the +X side end part of the main body part 81 in the state wherein they are spaced apart from one another by a prescribed distance in the Z axial directions (i.e., the vertical directions) and such that they are parallel to the XY plane. The −X side end part of the stator part 93a is noncontactually inserted between the two plate shaped members 82a₁, 82a₂. The plate shaped members 82a₁, 82a₂ respectively house magnet units MUa₁, MUa₂ (discussed below).

The slider part 82b comprises two plate shaped members 82b₁, 82b₂, which are maintained at a prescribed spacing in the Z axial directions (i.e., the vertical directions), and is bilaterally symmetric with and configured identically to the slider part 82a. The +X side end part of the stator part 93b is inserted noncontactually between the two plate shaped members 82b₁, 82b₂. The plate shaped members 82b₁, 82b₂ respectively house magnet units MUb₁, MUb₂, which are configured identically to the magnet units MUa₁, MUa₂, respectively.

Here, as discussed above, both side surfaces of the coarse motion stages WCS in the Y axial directions are open; therefore, when the fine motion stage WFS is mounted to the coarse motion stages WCS, the fine motion stage WFS should be positioned in the Z axial directions such that the stator parts 93a, 93b are positioned between the two plate shaped members 82a₁, 82a₂ and the two plate shaped members 82b₁, 82b₂, respectively; subsequently, the fine motion stage WFS should be moved (i.e., slid) in the Y axial directions.

The following text explains the configuration of the fine motion stage drive system 52 for driving the fine motion stage WFS with respect to the coarse motion stages WCS. The fine motion stage drive system 52 comprises: the pair of magnet units MUa₁, MUa₂, which are provided by the slider part 82a; the coil unit CUa, which is provided by the stator part 93a; the pair of magnet units MUb₁, MUb₂, which is provided by the slider part 82b; and the coil unit CUb, which is provided by the stator part 93b (all of which were discussed above).

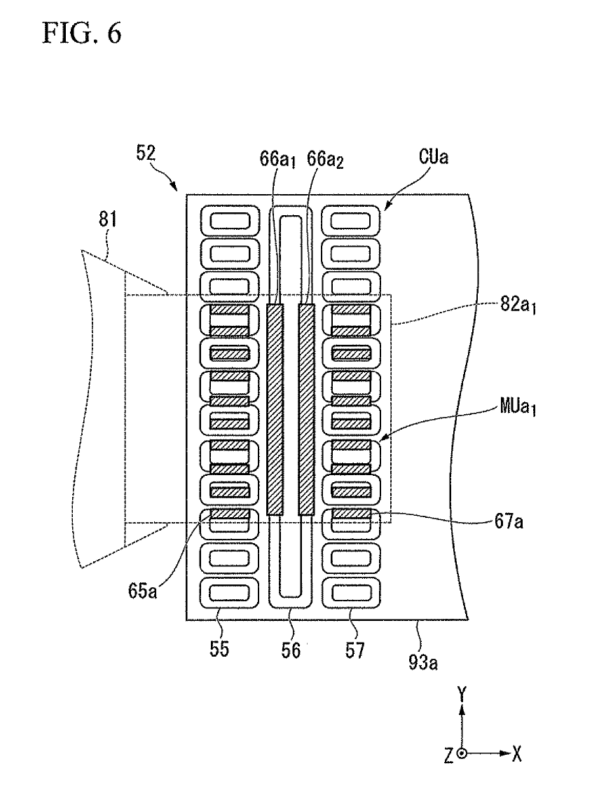

This will now be discussed in more detail. As can be understood from FIG. 6, a plurality of YZ coils 55 (55a, 55b), 57 (57a, 57b) (here, 12 each; hereinbelow, abbreviated as “coils” where appropriate), which are oblong in a plan view, are disposed equispaced in the Y axial directions inside the stator part 93a such that they constitute a two column coil array. The two columns of the coil array are disposed with a prescribed spacing between them in the X axial directions. Each of the YZ coils 55 comprises an upper part winding and a lower part winding (not shown), which are rectangular in a plan view and disposed such that they overlap in the vertical directions (i.e., the Z axial directions). In addition, one X coil 56 (hereinbelow, abbreviated as “coil” where appropriate), which in a plan view is a long, thin oblong whose longitudinal directions are oriented in the Y axial directions, is disposed inside the stator part 93a and between the columns of the two-column coil array discussed above. In this case, each of the columns of the two-column coil array and the X coil 56 are disposed equispaced in the X axial directions. Together, the two-column coil array and the X coil 56 constitute the coil unit CUa.

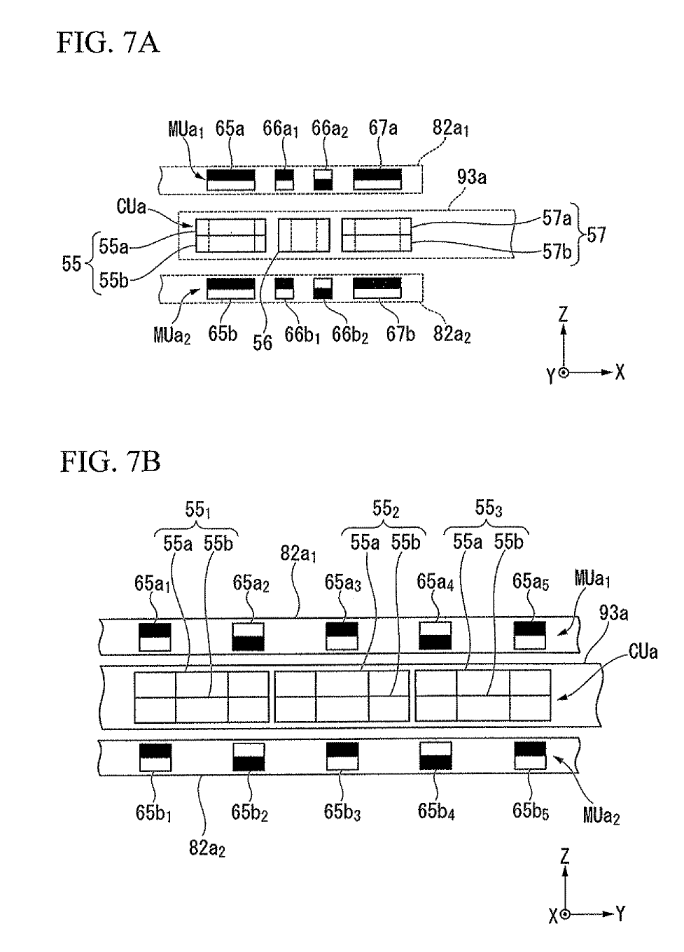

Furthermore, referencing FIG. 6, FIG. 7A, and FIG. 7B, the following text explains the stator part 93a of the stator parts 93a, 93b and the corresponding slider part 82a that is supported by the stator part 93a; however, the other (i.e., the −X side) stator part, namely, the stator part 93b, and the corresponding slider part 82b are identically configured and function in the same manner. Accordingly, the coil unit CUb and the magnet units MUb₁, MUb₂ are configured identically to the coil unit CUa and the magnet units MUa₁, MUa₂, respectively.

As can be understood by referencing FIG. 6, FIG. 7A, and FIG. 7B, a two column coil array, wherein permanent magnets 65a (herein, 10 of each) and permanent magnets 67a (herein, 10 of each), which are oblong in a plan view and whose longitudinal directions are oriented in the X axial directions, are disposed equispaced in the Y axial directions inside the plate shaped member 82a₁ on the +Z side, which constitutes part of the stator part 82a of the fine motion stage WFS, and the columns are disposed spaced apart in the X axial directions by a prescribed spacing. The columns of the two-column magnet array are disposed such that they oppose the coils 55, 57.

As shown in FIG. 713, the plurality of the permanent magnets 65a (65a₁, 65a₂, 65a₃, 65a₄, 65a₅ . . . , 65b₁, 65b₂, 65b₃, 65b₄, 65b₅ . . . ) is arrayed such that permanent magnets whose upper surface side (i.e., +Z side) is its N-pole and whose lower surface side (i.e., −Z side) is its S-pole and permanent magnets whose upper surface side (i.e., +Z side) is its S-pole and whose lower surface side (i.e., −Z side) is its N-pole alternate in the Y axial directions. The magnet column that comprises the plurality of the permanent magnets 67a (67a₁, 67a₂, 67a₃, 67a₄, 67a₅ . . . , 67b₁, 67b₂, 67b₃, 67b₄, 67b₅ . . . ) is configured identically to the magnet column that comprises the plurality of the permanent magnets 65a.

In addition, two permanent magnets 66a₁, 66a₂, which are disposed spaced apart in the X axial directions and whose longitudinal directions are oriented in the Y axial directions, are disposed inside the plate shaped member 82a₁ between the columns of the two-column magnet array discussed above such that they oppose the coil 56. As shown in FIG. 7A, the permanent magnet 66a₁ is configured such that its upper surface side (i.e., +Z side) is its N-pole and its lower surface side (i.e., −Z side) is its S-pole; furthermore, the permanent magnet 66a₂ is configured such that its upper surface side (i.e., +Z side) is its S-pole and its lower surface side (i.e., −Z side) is its N-pole.

The plurality of the permanent magnets 65a, 67a and 66a₁, 66a₂ (discussed above) constitutes the magnet unit MUa₁.

As shown in FIG. 7A, permanent magnets 65b, 66b₁, 66b₂, 67b similarly are disposed inside the −Z side plate shaped member 82a₂ with the same arrangement as in the +Z side plate shaped member 82a₁ discussed above. These permanent magnets 65b, 66b₁, 66b₂, 67b constitute the other magnet unit MUa₂. Furthermore, the permanent magnets 65b, 66b₁, 66b₂, 67b inside the −Z side plate shaped member 82a are disposed such that they respectively overlap the permanent magnets 65a, 66a₁, 66a₂, 67a on the paper plane far side in FIG. 6.

Here, as shown in FIG. 7B, in the fine motion stage drive system 52, the positional relationships (i.e., the individual spacings) in the Y axial directions between the plurality of permanent magnets 65 and the plurality of YZ coils 55 are set such that, with regard to the plurality of permanent magnets disposed adjacently in the Y axial directions (i.e., permanent magnets 65a₁-65a₅ arranged in linear order in the Y axial directions in FIG. 7B), when the two adjacent permanent magnets 65a₁ and 65a₂ each oppose a winding part of a YZ coil 55₁, the adjacent permanent magnet 65a₃ does not oppose a winding part of a YZ coil 55₂, which is adjacent to the YZ coil 55₁ discussed above (i.e., such that it opposes either the hollow at the center of the coil or the core around which the coil is wound, e.g., the iron core). Furthermore, as shown in FIG. 7B, each of the permanent magnets 65a₄ and 65a₅ opposes a winding part of a YZ coil 55₃, which is adjacent to the YZ coil 55₂. The spacings between the permanent magnets 65b, 67a, 67b in the Y axial directions are all the same (refer to FIG. 7B).

Accordingly, in the fine motion stage drive system 52 in the state shown in FIG. 7B as an example, if clockwise currents, viewed from the +Z direction, are supplied to each upper part winding and lower part winding of the coils 55₁, 55₃, then forces (i.e., Lorentz's forces) in the −Y direction will act on the coils 55₁, 55₃ and, in reaction thereto, forces in the +Y direction will act on the permanent magnets 65a, 65b. These forces act to move the fine motion stage WFS in the +Y direction with respect to the coarse motion stages WCS. If, on the other hand, counterclockwise currents, viewed from the +Z direction, are supplied to each of the coils 55₁, 55₃, then the fine motion stage WFS moves in the −Y direction with respect to the coarse motion stages WCS.

Supplying electric currents to the coils 57 induces an electromagnetic interaction between the permanent magnets 67 (67a, 67b), which makes it possible to drive the fine motion stage WFS in the Y axial directions. The main control apparatus 20 controls the position of the fine motion stage WFS in the Y axial directions by controlling the electric current supplied to each of the coils.

In addition, in the fine motion stage drive system 52 in the exemplary state shown in FIG. 7B, if a counterclockwise current, viewed from the +Z direction, is supplied to the upper part winding of the coil 55₂ and a clockwise current, viewed from the +Z direction, is supplied to the lower part winding of the coil 55₂, then an attraction force is generated between the coil 55₂ and the permanent magnet 65a₃ and a repulsion force is generated between the coil 55₂ and a permanent magnet 65b₃; furthermore, these attraction and repulsion forces move the fine motion stage WFS upward (i.e., in the +Z direction) with respect to the coarse motion stages WCS, namely, the forces levitate the fine motion stage WFS. The main control apparatus 20 controls the position of the fine motion stage WFS in the Z directions in the levitated state by controlling the electric currents supplied to each of the coils.

In addition, in the state shown in FIG. 7A, if a clockwise current, viewed from the +Z direction, is supplied to the coil 56, then a force (i.e., a Lorentz's force) in the +X direction acts on the coil 56 and, in reaction thereto, forces in the −X direction act on each of the permanent magnets 66a₁, 66a₂ and 66b₁, 66b₂, which moves the fine motion stage WFS in the −X direction with respect to the coarse motion stages WCS. In addition, if, on the other hand, a counterclockwise current, viewed from the +Z direction, is supplied to the coil 56, then forces in the +X direction act on the permanent magnets 66a₁, 66a₂ and 66b₁, 66b₂, which moves the fine motion stage WFS in the +X direction with respect to the coarse motion stages WCS. The main control apparatus 20 controls the position of the fine motion stage WFS in the X axial directions by controlling the electric currents supplied to each of the coils.

As is clear from the explanation above, in the present embodiment, the main control apparatus 20 drives the fine motion stage WFS in the Y axial directions by supplying an electric current to every other coil of the plurality of the YZ coils 55, 57 arrayed in the Y axial directions. In addition, in parallel therewith, the main control apparatus 20 levitates the fine motion stage WFS above the coarse motion stages WCS through generating driving forces in the Z axial directions that are separate from the driving forces in the Y axial directions by supplying electric currents to coils of the YZ coils 55, 57 that are not used to drive the fine motion stage WFS in the Y axial directions. Furthermore, by sequentially switching, in accordance with the position of the fine motion stage WFS in the Y axial directions, which of the coils are supplied with electric current, the main control apparatus 20 drives the fine motion stage WFS in the Y axial directions while maintaining the state wherein the fine motion stage WFS is levitated above the coarse motion stages WCS, namely, a noncontactual state. Furthermore, in the state wherein the fine motion stage WFS is levitated above the coarse motion stages WCS, the main control apparatus 20 can also drive the fine motion stage WFS independently in the X axial directions in addition to the Y axial directions.

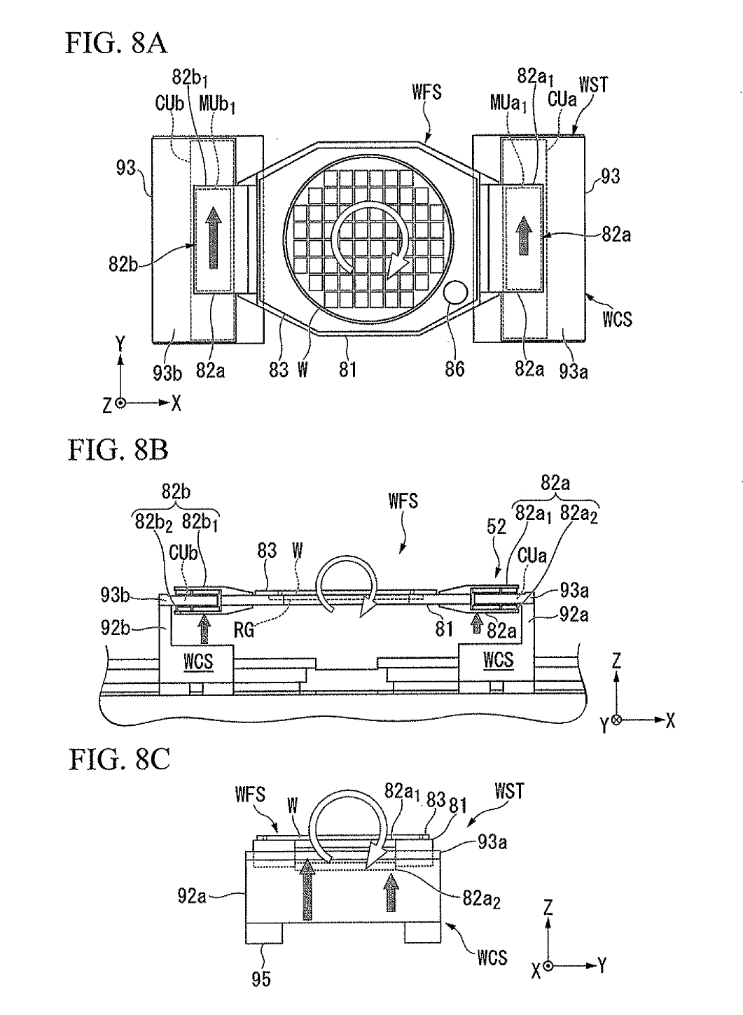

In addition, as shown in, for example, FIG. 8A, the main control apparatus 20 can rotate the fine motion stage WFS around the Z axis (i.e., can perform θz rotation; refer to the outlined arrow in FIG. 8A) by causing driving forces (i.e., thrusts) in the Y axial directions of differing magnitudes to act on the slider part 82a on the +X side and the slider part 82b on the −X side of the fine motion stage WFS (refer to the solid arrows in FIG. 8A).

In addition, as shown in FIG. 8B, the main control apparatus 20 can rotate the fine motion stage WFS around the Y axis (i.e., can perform θy drive (θy rotation); refer to the outlined arrow in FIG. 8B) by causing levitational forces of differing magnitudes to act on the slider part 82a on the +X side and the slider part 82b on the −X side of the fine motion stage WFS (refer to the solid arrows in FIG. 8B).

Furthermore, as shown in, for example, FIG. 8C, the main control apparatus 20 can rotate the fine motion stage WFS around the X axis (i.e., can perform θx drive (θx rotation); refer to the outlined arrow in FIG. 8C) by causing levitational forces of differing magnitudes to act on the +Y side slider part 82a and the −Y side slider part 82b of the fine motion stage WFS (refer to the solid arrows in FIG. 8C).

As is understood from the explanation above, in the present embodiment, the fine motion stage drive system 52 can levitationally support the fine motion stage WFS in a noncontactual state above the coarse motion stages WCS and can drive the coarse motion stages WCS noncontactually in directions corresponding to six degrees of freedom (i.e., in the X, Y, Z, θx, θy, and θz directions).

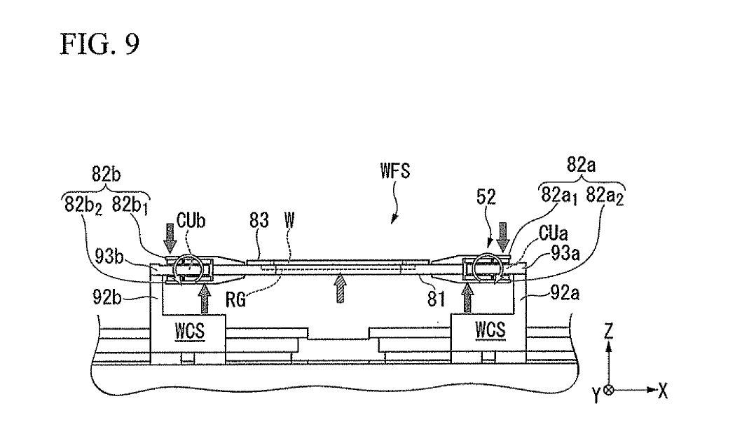

In addition, in the present embodiment, when levitational forces are caused to act on the fine motion stage WFS, the main control apparatus 20 can cause a rotational force around the Y axis to act on the slider part 82a (refer to the outlined arrow in FIG. 9) at the same time that levitational forces act on the slider part 82a (refer to the solid arrow in FIG. 9), as shown in, for example, FIG. 9, by supplying electric currents in opposite directions to the two columns of coils 55, 57 (refer to FIG. 6) disposed inside the stator part 93a. In addition, the main control apparatus 20 can flex in the +Z direction or the −Z direction (refer to the hatched arrow in FIG. 9) the center part of the fine motion stage WFS by causing rotational forces around the Y axis to act on the slider parts 82a, 82b in opposite directions. Accordingly, as shown in FIG. 9, it can ensure a degree of parallelism between the front surface of the wafer W and the XY plane (i.e., the horizontal plane) by flexing in the +Z direction the center part of the fine motion stage WFS and thereby canceling the flexure in the X axial directions of an intermediate portion of the fine motion stage WFS (i.e., the main body part 81) owing to the self weights of the wafer W and the main body part 81. Thereby, this aspect is particularly effective when, for example, the size of the wafer W or of the fine motion stage WFS is increased.

In the exposure apparatus 100 of the present embodiment, when a step-and-scan type exposure operation is being performed on the wafer W, the main control apparatus 20 uses an encoder system 73 (refer to FIG. 5) of the fine motion stage position measuring system 70 (discussed below) to measure the position within the XY plane (including the position in the θz directions) of the fine motion stage WFS. The positional information of the fine motion stage WFS is sent to the main control apparatus 20, which, based thereon, controls the position of the fine motion stage WFS.

In contrast, when the wafer stage WST is positioned outside of the measurement area of the fine motion stage position measuring system 70, the main control apparatus 20 uses the wafer stage position measuring system 16 (refer to FIG. 5) to measure the position of the wafer stage WST. As shown in FIG. 1, the wafer stage position measuring system 16 comprises laser interferometers, which radiate length measurement beams to reflective surfaces, which are formed by mirror polishing the side surfaces of the coarse motion stages WCS, and measures the position within the XY plane of the wafer stage WST. Furthermore, although not shown in FIG. 1, in actuality, a Y reflective surface that is perpendicular to the Y axis and an X reflective surface that is perpendicular to the X axis are formed in each of the coarse motion stages WCS and, correspondingly, X laser interferometers and Y laser interferometers, which radiate length measurement beams to the X reflective surfaces and the Y reflective surfaces, are provided. Furthermore, in the wafer stage position measuring system 16, for example, the Y interferometer has a plurality of length measuring axes and, based on the outputs of measurements taken along these length measuring axes, can also measure the position (i.e., rotation) of the wafer stage WST in the θz directions. Furthermore, instead of using the wafer stage position measuring system 16 discussed above to measure the position within the XY plane of the wafer stage WST, some other measuring apparatus, for example, an encoder system, may be used. In such a case, for example, a two dimensional scale can be disposed on the upper surface of the base plate 12, and an encoder head can be provided to each of the bottom surfaces of the coarse motion stages WCS.

The following text explains the configuration of the fine motion stage position measuring system 70 (refer to FIG. 5), which comprises: the encoder system 73, which is used to measure the position of the fine motion stage WFS within the XY plane; and the laser interferometer system 75, which is used to measure the position of the fine motion stage WFS in the Z, θx, and θy directions. As shown in FIG. 1, the fine motion stage position measuring system 70 comprises a measuring arm 71, which is inserted in the space provided inside each of the coarse motion stages WCS in the state wherein the wafer stage WST is disposed below the projection optical system PL. The measuring arm 71 is supported in a cantilevered state by the main frame BD of the exposure apparatus 100 via a support part 72 (i.e., the vicinity of one-end part is supported).

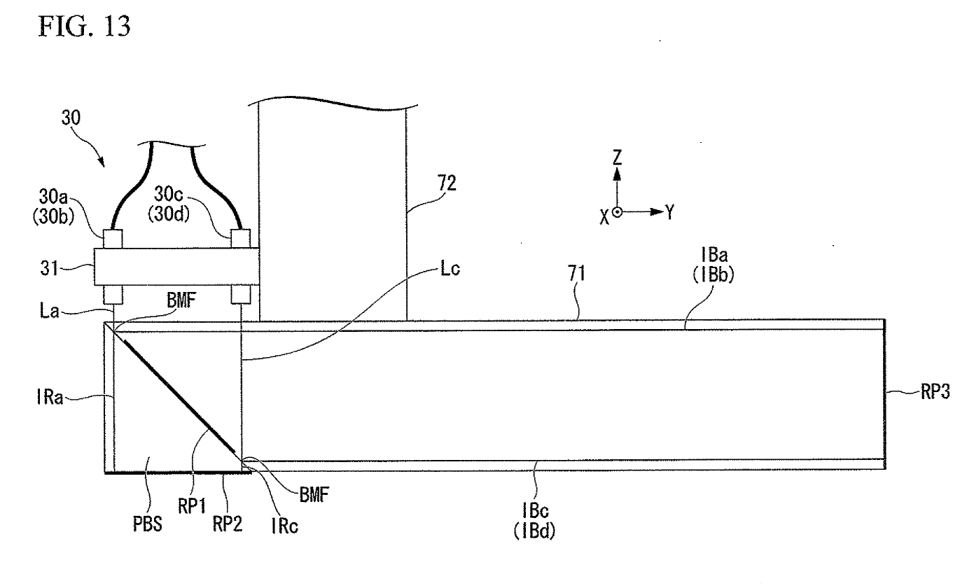

The measuring arm 71 is a square columnar member (i.e., a rectangular parallelepipedic member) whose longitudinal directions are oriented in the Y axial directions and whose longitudinal oblong cross section is such that the size in the height directions (i.e., the Z axial directions) is greater than the size in the width directions (i.e., the X axial directions); furthermore, the measuring arm 71 is formed from the identical raw material wherethrough the light transmits, for example, by laminating together a plurality of glass members. As shown in FIG. 13, the measuring arm 71 comprises: a first member, which is positioned on the −Y side end part and is shaped as a right angle prism; and a second member, which together with the first member constitutes a member that has a square columnar shape (i.e., a rectangular parallelepipedic) as a whole. The measuring arm 71 is formed as a solid, excepting the portion wherein the encoder head (i.e., the optical system) is housed (discussed below). As shown in FIG. 13, a reflective surface RP1 is formed by forming a reflective film at the interface surface between the first member and the second member (i.e., the inclined surface of the first member), excluding the vicinity of the outer circumferential part thereof; furthermore, a Brewster's splitting plane BMF (hereinbelow, abbreviated as “splitting plane”) is formed in at least the upper end part and the lower end part of the outer circumferential part of the reflective surface RP1. Namely, the first member constitutes a polarizing beam splitter, part of which has a reflective surface. Hereinbelow, the first member is called a first member PBS (also called a “polarizing beam splitter” where appropriate). A reflective surface RP2 is formed by forming a reflective film over the entire surface of the side surface of the first member PBS.

In addition, a reflective surface RP3 is formed by forming a reflective film over the entire surface of the +Y side end surface of the measuring arm 71. A method of using the reflective surface RP3 will be discussed later.

As discussed above, a tip part of the measuring arm 71 is inserted in the spaces of the coarse motion stages WCS in the state wherein the wafer stage WST is disposed below the projection optical system PL; furthermore, as shown in FIG. 1, the upper surface of the measuring arm 71 opposes the lower surface of the fine motion stage WFS (more accurately, the lower surface of the main body part 81; not shown in FIG. 1; refer to FIG. 4A and the like). The upper surface of the measuring arm 71 is disposed substantially parallel to the lower surface of the fine motion stage WFS in the state wherein a prescribed clearance, for example, approximately several millimeters, is formed between the upper surface of the measuring arm 71 and the lower surface of the fine motion stage WFS.

As shown in FIG. 5, the fine motion stage position measuring system 70 comprises: the encoder system 73, which measures the position of the fine motion stage WFS in the X axial, Y axial, and θz directions; and the laser interferometer system 75, which measures the position of the fine motion stage WFS in the Z axial, θx, and θy directions. The encoder system 73 comprises an X linear encoder 73x, which measures the position of the fine motion stage WFS in the X axial directions, and a pair of Y linear encoders 73ya, 73yb (hereinbelow, collectively called the “Y linear encoder 73y” where appropriate), which measures the position of the fine motion stage WFS in the Y axial directions. The encoder system 73 uses diffraction interference type heads with a configuration identical to that of the encoder head (herein below, abbreviated as “head” where appropriate) disclosed in, for example, U.S. Pat. No. 7,238,931 and PCT International Publication No. WO2007/083758 (and corresponding U.S. Patent Application Publication No. 2007/288121). However, in the head of the present embodiment, the light source discussed above and a light receiving system (including a photodetector) are disposed outside of the measuring arm 71 (as discussed below), and only the optical system is disposed inside the measuring arm 71, namely, opposing the grating RG. Unless it is particularly necessary to use its full name, the optical system disposed inside the measuring arm 71 is called a head.

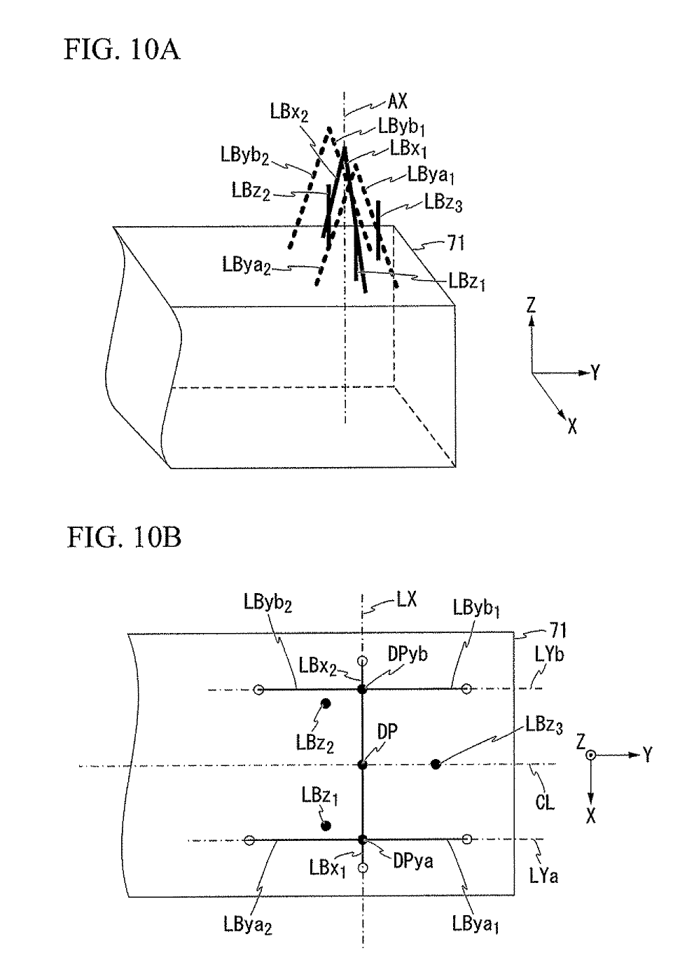

FIG. 10A is an oblique view of the tip part of the measuring arm 71, and FIG. 1013 is a plan view, viewed from the +Z direction, of the upper surface of the tip part of the measuring arm 71. The encoder system 73 uses one X head 77x (refer to FIG. 11A and FIG. 11B) to measure the position of the fine motion stage WFS in the X axial directions, and uses a pair of Y heads 77ya, 77yb (refer to FIG. 11B) to measure the position of the fine motion stage WFS in the Y axial directions. Namely, the X linear encoder 73x (discussed above) comprises the X head 77x that uses the X diffraction grating of the grating RG to measure the position of the fine motion stage WFS in the X axial directions, and the pair of Y linear encoders 73ya, 73yb comprises the pair of Y heads 77ya, 77yb that uses the Y diffraction grating of the grating RG to measure the position of the fine motion stage WFS in the Y axial directions.

As shown in FIG. 10A and FIG. 10B, the X head 77x radiates measurement beams LBx₁, LBx₂ (indicated by solid lines in FIG. 10A) to the grating RG (refer to FIG. 10A) from two points on a straight line LX parallel to the X axis (refer to the white circles in FIG. 10B), which are equidistant from a centerline CL of the measuring arm 71. The measurement beams LBx₁, LBx₂ are radiated to the same irradiation point on the grating RG (refer to FIG. 11A). The irradiation point of the measurement beams LBx₁, LBx₂, namely, the detection point of the X head 77x (refer to symbol DP in FIG. 10B) coincides with the exposure position (refer to FIG. 1), which is the center of the irradiation area IA (i.e., the exposure area) of the illumination light IL radiated to the wafer W. Furthermore, although the measurement beams LBx₁, LBx₂ are in actuality refracted by, for example, the interface surface between the main body part 81 and the air layer, this aspect is shown in a simplified form in FIG. 11A and the like.

As shown in FIG. 11B, the two Y heads 77ya, 77yb are disposed on opposite sides of the centerline CL of the measurement arm 71, one on the +X side and one on the −X side. As shown in FIG. 10A and FIG. 10B, the Y head 77ya radiates measurement beams LBya₁, LBya₂, which are indicated by broken lines in FIG. 10A, from two points (refer to the white circles in FIG. 10B), which are equidistant from the straight line LX and disposed along a straight line LYa parallel to the Y axis, to a common irradiation point on the grating RG. The irradiation point of the measurement beams LBya₁, LBya₂, namely, the detection point of the Y head 77ya, is indicated by a symbol DPya in FIG. 10B.

The Y head 77yb radiates measurement beams LByb₁, LByb₂ to a common irradiation point DPyb on the grating RG from two points (refer to the white circles in FIG. 10B) that are equidistant from the straight line LX and are disposed on a straight line LYb that, like the Y head 77ya, is parallel to the Y axis and spaced apart from the centerline CL of the measuring arm 71 by the same distance as the straight line LYa. As shown in FIG. 10B, the detection points DPya, DPyb of the measurement beams LBya₁, LBya₂ and the measurement beams LByb₁, LByb₂, respectively, are disposed along the straight line LX, which is parallel to the X axis. Here, the main control apparatus 20 determines the position of the fine motion stage WFS in the Y axial directions based on the average of the measurement values of the two Y heads 77ya, 77yb. Accordingly, in the present embodiment, the position of the fine motion stage WFS in the Y axial directions is measured such that the midpoint of the detection points DPya, DPyb serves as the effective measurement point. Furthermore, the midpoint of the detection points DPya, DPyb detected by the Y heads 77ya, 77yb coincides with the irradiation point DP of the measurement beams LBx₁, LBx₂ on the grating RG. Namely, in the present embodiment, the positional measurements of the fine motion stage WFS in the X axial directions and the Y axial directions have a common detection point and this detection point coincides with the exposure position, which is the center of the irradiation area IA (i.e., the exposure area) of the illumination light IL radiated to the wafer W. Accordingly, in the present embodiment, the main control apparatus 20 can use the encoder system 73 to continuously measure—directly below the exposure position (i.e., on the rear side)—the position of the fine motion stage WFS within the XY plane when the pattern of the reticle R is transferred to a prescribed shot region on the wafer W mounted on the fine motion stage WFS. In addition, based on the difference in the measurement values of the two Y heads 77ya, 77yb, which each are disposed spaced apart in the X axial directions and measure the position of the fine motion stage WFS in the Y axial directions, the main control apparatus 20 measures the amount of rotation in the θz directions of the fine motion stage WFS.

Here, the configuration of the three heads 77x, 77ya, 77yb that constitute the encoder system 73 will be explained. FIG. 11A shows a schematic configuration of the X head 77x, which represents all three of the heads 77x, 77ya, 77yb. In addition, FIG. 11B shows the arrangement of the X head 77x and the Y heads 77ya, 77yb inside the measuring arm 71.

As shown in FIG. 11A, the X head 77x comprises: the polarizing beam splitter PBS, whose splitting plane is parallel to the YZ plane; a pair of reflective mirrors R1a, R1b; a pair of lenses L2a, L2b; a pair of quarter wave plates WP1a, WP1b (hereinbelow, denoted as λ/4 plates); a pair of reflective mirrors R2a, R2b; and a pair of reflective mirrors R3a, R3b; furthermore, these optical elements are disposed with prescribed positional relationships. The optical systems of the Y heads 77ya, 77yb also have the same configuration. As shown in FIG. 11A and FIG. 11B, the X head 77x and the Y heads 77ya, 77yb are each unitized and fixed inside the measuring arm 71.

As shown in FIG. 11B, in the X head 77x (i.e., the X linear encoder 73x), a light source LDx, which is provided to the upper surface of the −Y side end part of the measuring arm 71 (or there above), emits in the −Z direction a laser beam LBx₀, the laser beam LBx₀ transits the reflective surface RP1 (discussed above), which is provided such that the reflective surface RP1 is tilted at a 45° angle with respect to the XY plane, and the optical path of the laser beam LBx₀ is thereby folded in a direction parallel to the Y axial directions. The laser beam LBx₀ advances parallel to the longitudinal directions (i.e., the Y axial directions) of the measuring arm 71 through the solid portion inside the measuring arm 71 and reaches the reflective mirror R3a shown in FIG. 11A. Furthermore, the reflective mirror R3a folds the optical path of the laser beam LBx₀, and the laser beam LBx₀ thereby impinges the polarizing beam splitter PBS. The polarizing beam splitter PBS polarizes and splits the laser beam LBx₀, which becomes the two measurement beams LBx₁, LBx₂. The measurement beam LBx₁, which transmits through the polarizing beam splitter PBS, reaches the grating RG, which is formed in the fine motion stage WFS, via the reflective mirror R1a; furthermore, the beam LBx₂, which is reflected by the polarizing beam splitter PBS, reaches the diffraction grating RG via the reflective mirror R1b. Furthermore, “polarization splitting” herein means the splitting of the incident beam into a P polarized light component and an S polarized light component.

Diffraction beams of a prescribed order (e.g., first order diffraction beams), which are generated by the grating RG as a result of the radiation of the beams LBx₁, LBx₂, transit the lenses L2a, L2b, are converted to circularly polarized beams by the λ/4 plates WP1a, WP 1b, are subsequently reflected by the reflective mirrors R2a, R2b, pass once again through the λ/4 plates WP 1a, WP1b, and reach the polarizing beam splitter PBS by tracing the same optical path as the forward path, only in reverse.

The polarized directions of each of the two first order diffraction beams that reach the polarizing beam splitter PBS are rotated by 90° with respect to the original directions. Consequently, the first order diffraction beam of the measurement beam LBx₁ that previously transmitted through the polarizing beam splitter PBS is reflected by the polarizing beam splitter PBS. The first order diffraction beam of the measurement beam LBx₂ that was previously reflected by the polarizing beam splitter PBS transmits through the polarizing beam splitter PBS. Thereby, the first order diffraction beams of the measurement beams LBx₁, LBx₂ are combined coaxially as a combined beam LBx₁₂. The reflective mirror R3b folds the optical path of the combined beam LBx₁₂ such that it is parallel to the Y axis, after which the combined beam LBx₁₂ travels parallel to the axis inside the measuring arm 71, transits the reflective surface RP1 (discussed above), and is sent to an X light receiving system 74x, which is disposed outside of the measuring arm 71, as shown in FIG. 11B.

In the X light receiving system 74x, the first order diffraction beams of the measurement beams LBx₁, LBx₂, which were combined into the combined beam LBx₁₂, are aligned in polarization directions by a polarizer (i.e., an analyzer), which is not shown, and therefore interfere with one another to form an interfered beam, which is detected by the photodetector (not shown) and then converted to an electrical signal that corresponds to the intensity of the interfered beam. Here, when the fine motion stage WFS moves in either of the measurement directions (in this case, the X axial directions), the phase difference between the two beams changes, and thereby the intensity of the interfered beam changes. These changes in the intensity of the interfered beam are supplied to the main control apparatus 20 (refer to FIG. 5) as the positional information in the X axial directions of the fine motion stage WFS.

As shown in FIG. 11B, laser beams LBya₀, LByb₀, which are respectively emitted from light sources LDya, LDyb and whose optical paths are folded by 90° by the reflective surface RP1 (discussed above) such that the beams travel parallel to the Y axis, enter the Y heads 77ya, 77yb and, the same as discussed above, combined beams LBya₁₂, LByb₁₂ of the first order diffraction beams diffracted by the grating RG (i.e., the Y diffraction grating) from the measurement beams polarized and split by the polarizing beam splitters are output from the Y heads 77ya, 77yb, respectively, and then return to Y light receiving systems 74ya, 74yb. Here, the light source LDya and the light receiving system 74ya as well as the light source LDyb and the light receiving system 74yb are disposed such that they are arrayed in the Y axial directions, as shown in FIG. 11B. Accordingly, the laser beams LBya₀, LByb₀, which were emitted from the light sources LDya, LDyb, and the combined beams LBya₁₂, LByb₁₂, which return to the Y light receiving systems 74ya, 74yb, travel with overlapping optical paths in the directions perpendicular to the paper plane in FIG. 11B. In addition, as discussed above, inside the Y heads 77ya, 77yb, the optical paths of the laser beams LBya₀, LByb₀ emitted from the light sources and the optical paths of the combined beams LBya₁₂, LByb₁₂ that return to the Y light receiving systems 74ya, 74yb are folded as appropriate (not shown) such that those optical paths are parallel and spaced apart in the Z axial directions.

As shown in FIG. 10A, the laser interferometer system 75 causes three length measurement beams LBz₁, LBz₂, LBz₃ to emerge from the tip part of the measuring aim 71 and impinge the lower surface of the fine motion stage WFS. The laser interferometer system 75 comprises three laser interferometers 75a-75c (refer to FIG. 5), each of which radiates one of these three length measurement beams LBz₁, LBz₂, LBz₃.

In the laser interferometer system 75, as shown in FIG. 10A and FIG. 10B, the three length measurement beams LBz₁, LBz₂, LBz₃ emerge parallel to the Z axis from three points on the upper surface of the measuring arm 71 that are not on the same straight line. Here, as shown in FIG. 10B, the center of gravity of the three length measurement beams LBz₁, LBz₂, LBz₃ corresponds with the exposure position, which is the center of the irradiation area IA (i.e., the exposure area), and the three length measurement beams LBz₁, LBz₂, LBz₃ emerge from the vertices of an isosceles triangle (or a regular triangle). In this case, the emitting point (i.e., the radiation point) of the length measurement beam LBz₃ is positioned on the centerline CL, and the emitting points (i.e., the radiation points) of the remaining length measurement beams LBz₁, LBz₂ are equidistant from the centerline CL. In the present embodiment, the main control apparatus 20 uses the laser interferometer system 75 to measure the position in the Z axial directions and the amounts of rotation in the θz and θy directions of the fine motion stage WFS. Furthermore, the laser interferometers 75a-75c are provided to the upper surface of the −Y side end part of the measuring arm 71 (or there above). The length measurement beams LBz₁, LBz₂, LBz₃, which are emitted in the −Z direction from the laser interferometers 75a-75c transit the reflective surface RP1 (discussed above), travel along the Y axial directions inside the measuring arm 71, wherein their optical paths are folded, and emerge from the three points discussed above.

In the present embodiment, a wavelength selecting filter (not shown), which transmits the measurement beams from the encoder system 73 but hinders the transmission of the length measurement beams from the laser interferometer system 75, is provided to the lower surface of the fine motion stage WFS. In this case, the wavelength selecting filter serves double duty as the reflective surface of the length measurement beams from the laser interferometer system 75.

As can be understood from the explanation above, using the encoder system 73 of the fine motion stage position measuring system 70 and the laser interferometer system 75, the main control apparatus 20 can measure the position of the fine motion stage WFS in directions corresponding to six degrees of freedom. In this ease, in the encoder system 73, the in-air optical path lengths of the measurement beams are extremely short and substantially equal, and consequently the effects of air turbulence are virtually inconsequential. Accordingly, the encoder system 73 can measure, with high accuracy, the position of the fine motion stage WFS within the XY plane (including the θz directions). In addition, because the effective detection point of the encoder system 73 on the grating in the X axial directions and in the Y axial directions and the effective detection point of the laser interferometer system 75 on the lower surface of the fine motion stage WFS in the Z axial directions coincide with the center (i.e., the exposure position) of the exposure area IA, so-called Abbé error is suppressed to such a degree that it is substantially inconsequential. Accordingly, using the fine motion stage position measuring system 70, the main control apparatus 20 can measure, with high accuracy, the position of the fine motion stage WFS in the X axial directions, the Y axial directions, and the Z axial directions without Abbé error.

Incidentally, in the exposure apparatus 100 of the present embodiment, although the main frame BD, the base plate 12, and the like are installed via a vibration isolating mechanism (not shown), there is still a possibility that, for example, vibrations generated by various movable apparatuses fixed to the main frame BD will transmit to the measuring arm 71 via the support part 72 during an exposure. In such a case, because the measuring arm 71 is the cantilever of a cantilevered support structure, there is a possibility that the measuring arm 71 will deform, for example, flex, owing to the abovementioned vibrations, the optical axes of the heads 77x, 77ya, 77yb that constitute the encoder system 73 will tilt with respect to the Z axis, and that measurement error in the measurement of the fine motion stage WFS will arise as disclosed in the mechanism of, for example, PCT International Publication No. WO2008/026732.

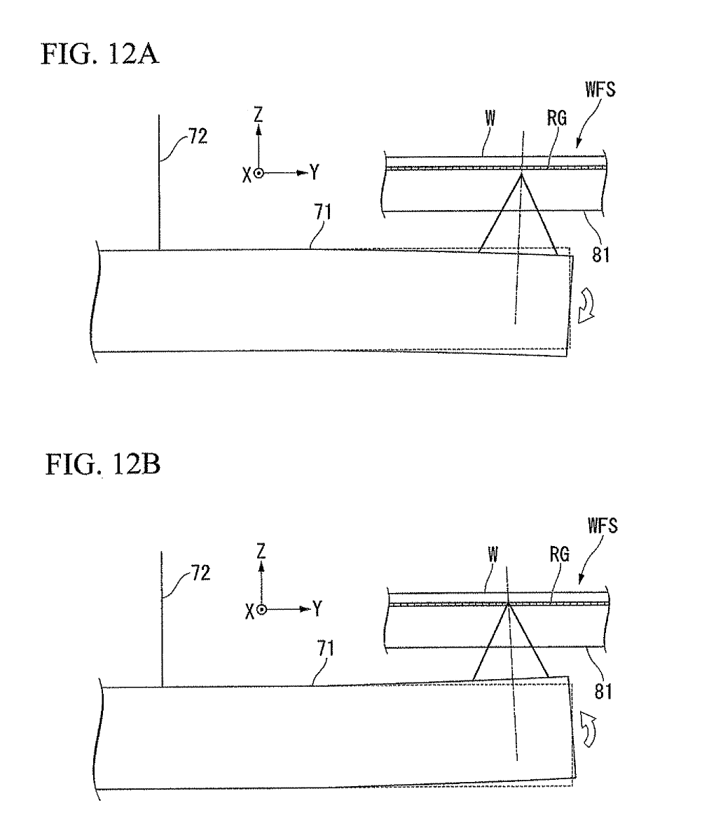

FIG. 12A and FIG. 12B show a case wherein the tip part of the measuring arm 71 moves vertically (i.e., vibrates longitudinally) in the Z axial directions (i.e., the vertical directions), which is the simplest example of the measuring arm 71 flexing owing to vibrations. The abovementioned vibrations manifest in the measuring arm 71 as a periodic switching between the flexure shown in FIG. 12A and the flexure shown in FIG. 12B; thereby, the optical axes of the heads 77x, 77ya, 77yb of the encoder system 73 tilt and the effective detection point DP of the X head 77x and the effective detection points of the Y heads 77ya, 77yb move periodically in the +Y direction and the −Y direction with respect to the exposure position. In addition, the distances in the Z axial directions between the grating RG and each of the heads 77x, 77ya, 77yb also vary periodically.

Here, as disclosed in the PCT International Publication No. WO2008/026732 and the like, which was discussed above, even if the tilts of the optical axes of each of the heads 77x, 77ya, 77yb with respect to the grating RG result in measurement error of the encoder system 73 and, furthermore, even if these tilts of the optical axes are the same, as long as the distances between the gratings RG and each of the heads 77x, 77ya, 77yb differ, the measurement error would also vary in accordance with the distances.

To avoid such a problem, in the exposure apparatus 100 of the present embodiment, the main control apparatus 20 continuously measures the change in the shape of the measuring arm 71, specifically, the change in the surface position of the tip surface of the measuring arm 71 (i.e., the end surface on the free end side), namely, the main control apparatus 20 continuously measures the tilt of the optical axis of each of the heads 77x, 77ya, 77yb of the encoder system 73 with respect to the grating RG and uses correction information of the encoder system 73, which is generated in advance by a technique identical to the one disclosed in PCT International Publication No. WO2008/026732 (discussed above) and the like, to correct the measurement error of the encoder system 73. Here, the correction of the measurement error of the encoder system 73 in the explanation below does not consider measurement error owing to vibrations of the measuring arm 71 in the θy directions but rather considers only measurement error that arises during the generation of the longitudinal vibrations discussed above (i.e., measurement error owing to vibrations in the θx directions), measurement error that arises when the tip of the measuring arm 71 vibrates in the θz directions (i.e., lateral vibrations), and measurement error that arises when the abovementioned longitudinal vibrations and lateral vibrations occur in combination. Furthermore, the present invention is not limited thereto; for example, the amount of displacement of the measuring arm 71 in the θy directions may be measured and the measurement error owing to the displacement in the θy directions may be corrected in combination with the measurement error owing to the displacement in the θx and θz directions.

In the exposure apparatus 100 of the present embodiment, the main control apparatus 20 derives the change in the shape of the measuring arm 71 by measuring the position (i.e., the surface position) of the tip surface of the measuring arm 71. In FIG. 13, a measuring system 30 (refer to FIG. 5) for measuring the surface position of the tip surface of the measuring arm is shown. The measuring system 30 comprises four laser interferometers 30a-30d, but the laser interferometers 30b, 30d are hidden on the paper plane far side in FIG. 13 of the laser interferometers 30a, 30c.

As shown in FIG. 13, each of the laser interferometers 30a-30d is supported by a pair of support members 31 that is fixed to the −Y side surface of the support part 72 in the vicinity of the lower end part. Namely, the laser interferometers 30a, 30c are supported by the support members 31 on the paper plane near side in FIG. 13 such that they are spaced apart by a prescribed spacing in the Y axial directions, and the laser interferometers 30b, 30d are supported by the support members 31 on the paper plane far side in FIG. 13 such that they are spaced apart by a prescribed spacing in the Y axial directions. Each of the laser interferometers 30a-30d emits laser light in the −Z direction.

For example, a laser light La emitted from the laser interferometer 30a is polarized and split into a reference beam IRa and a length measurement beam IBa by the splitting plane BMF positioned at the upper end part of the first member PBS. The reference beam IRa is reflected by the reflective surface RP2, transits the splitting plane BMF and then returns to the laser interferometer 30a. Moreover, the length measurement beam Ma transmits through the solid portion in the vicinity of the +X side of the +Z side end part of the measuring arm 71 along an optical path that is parallel to the Y axis and reaches the reflective surface RP3, which is formed on the +Y side end part of the measuring arm 71. Furthermore, the length measurement beam IBa is reflected by the reflective surface RP3, traces the original optical path in the reverse direction, coaxially combines with the reference beam IRa and then returns to the laser interferometer 30a. Inside the laser interferometer 30a, a polarizer aligns the polarization directions of the reference beam IRa and the length measurement beam IBa, which interfere with one another and transition to an interfered beam; furthermore, this interfered beam is detected by a photodetector (not shown) and then converted to an electrical signal in accordance with its intensity.

A laser light Lc emitted from the laser interferometer 30c is polarized and split into a reference beam IRc and a length measurement beam IBc by the splitting plane BMF positioned at the lower end part of the first member PBS. The reference beam IRc is reflected by the reflective surface RP2, transits the splitting plane BMF and then returns to the laser interferometer 30c. Moreover, the length measurement beam IBc transmits through the solid portion in the vicinity of the +X side of the −Z side end part of the measuring arm 71 along an optical path that is parallel to the Y axis and reaches the reflective surface RP3. Furthermore, the length measurement beam IBc is reflected by the reflective surface RP3, traces the original optical path in the reverse direction, coaxially combines with the reference beam IRc and then returns to the laser interferometer 30c. Inside the laser interferometer 30c, a polarizer aligns the polarization directions of the reference beam IRc and the length measurement beam IBc, which interfere with one another and transition to an interfered beam; furthermore, this interfered beam is detected by a photodetector (not shown) and then converted to an electrical signal in accordance with its intensity.

In the remaining laser interferometers 30b, 30d, length measurement beams and reference beams trace the same optical paths as the laser interferometers 30a, 30c, and electrical signals in accordance with the intensities of their interfered beams are output from photodetectors. In this case, with respect to the YZ plane wherethrough the center of the arm member in an XZ cross section passes, the optical paths of the length measurement beams IBb, IBd of the laser interferometers 30b, 30d are bilaterally symmetric to the optical paths of the length measurement beams IBa, IBc. Namely, the length measurement beams IBa-IBd of the laser interferometers 30a-30d transmit through the solid portion of the measuring arm 71, are reflected by the portions corresponding to the four corner parts of the tip surface of the measuring arm 71, trace the same optical paths, and return to the laser interferometers 30a-30d.

The laser interferometers 30a-30d send information corresponding to the intensities of the interfered beams produced by the reflected beams of the length measurement beams IBa-IBd and the reflected beams of the reference beams IRa-IRd to the main control apparatus 20. Based on this information and using the reflective surface RP2 as a reference, the main control apparatus 20 derives the positions of the radiation points of the length measurement beams IBa-IBd at the four corner parts on the tip surface (i.e., the reflective surface RP3) of the measuring arm 71, namely, measures the optical path lengths of the length measurement beams IBa-IBd. Furthermore, a laser interferometer of the type wherein, for example, a reference mirror is built in may be used as each of the laser interferometers 30a-30d. Alternatively, instead of the laser interferometers 30a-30d, an interferometer system may be used wherein one or two laser beams output from one or two light sources are divided to generate the length measurement beams IBa-IBd, and information corresponding to the intensities of the interfered beams produced by combining the length measurement beams and the reference beams is used. In this case, a single laser beam may be divided multiple times to generate the length measurement beams and the reference beams, and the optical path lengths of the multiple length measurement beams may be measured using the reference beams generated from the single laser beam as references.

The main control apparatus 20 derives the surface position information (i.e., the inclination angle) of the tip surface of the measuring arm 71 based on changes in the outputs of the laser interferometers 30a-30d, namely, changes in the optical path lengths of the length measurement beams IBa-IBd. More specifically, if, for example, the deformation shown in FIG. 12A arises in the measuring arm 71, then the optical path lengths of the length measurement beams IBa, IBb of the two laser interferometers 30a, 30b disposed on the +Z side corners of the four corner parts on the fixed end side of the measuring arm 71 will lengthen, and the optical path lengths of the length measurement beams IBc, IBd of the laser interferometers 30c, 30d disposed on the −Z side will shorten. In addition, if the deformation shown in FIG. 12B arises in the measuring arm 71, then, conversely, the optical path lengths of the length measurement beams IBa, IBb will shorten and the optical path lengths of the length measurement beams IBc, IBd will lengthen. Based on the surface position information of the tip surface of the measuring arm 71, the main control apparatus 20 derives the inclination angles of the optical axes of the heads 77x, 77ya, 77yb with respect to the Z axis and the distances between each of the heads 77x, 77ya, 77yb and the grating RG, derives the measurement error of each of the heads 77x, 77ya, 77yb of the encoder system 73 based on the inclination angles, the distances, and the correction information, which is discussed below, and uses the derived measurement errors to correct the measurement values.

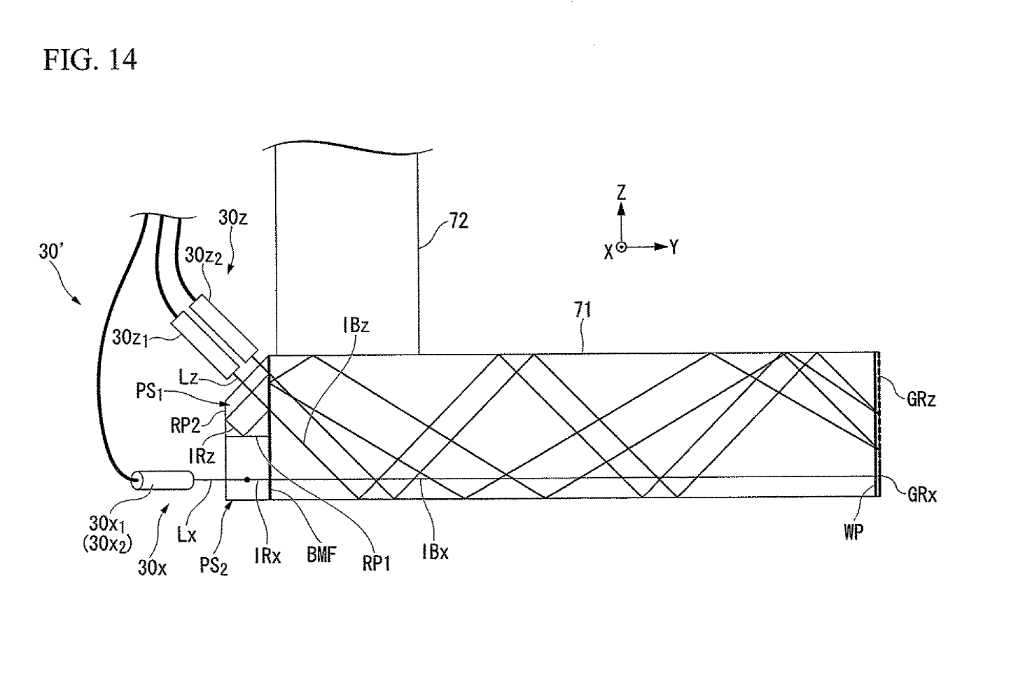

Furthermore, measuring the displacement of the tip surface of the measuring arm 71 (i.e., the displacement in directions parallel to the tip surface) makes it possible to also measure changes in the shape of the measuring arm 71. FIG. 14 shows a measuring system 30′, which is for measuring the displacement of the tip surface of the measuring arm, as a modified example of the measuring system 30 discussed above.

The measuring system 30′ comprises two encoders 30z, 30x. The encoder 30z comprises a light source 30z₁ and a light receiving device 30z₂. The encoder 30x comprises a light source 30x₁ and a light receiving device 30x₂. As shown in FIG. 14, the light source 30z₁ and the light receiving device 30z₂ are supported by support members (not shown), which are fixed to the −Y side surface of the support part 72 in the vicinity of the lower end part, in the state wherein the longitudinal directions of the light source 30z₁ and the light receiving device 30z₂ are parallel to the YZ plane and form a 45° angle with respect to the XY plane and the XZ plane. In addition, the light source 30x₁ and the light receiving device 30x₂ are supported by support members (not shown) in the state wherein the longitudinal directions of the light source 30x₁ and the light receiving device 30x₂ are parallel to the XY plane and form a 45° angle with respect to the YZ plane and the XZ plane. However, because the light receiving device 30x₂ is positioned on the −X side (i.e., the paper plane far side in FIG. 14) with respect to the light source 30x₁, it is hidden on the far side of the light source 30x₁.

An optical member PS₁ is fixed to a −Y end part of the measuring arm 71 on the +Z side thereof. The optical member PS₁ is a hexahedral member that has a trapezoidal shape in a YZ cross section (i.e., the cross section perpendicular to the X axis) as shown in FIG. 14 and a prescribed length in the X axial directions. The inclined surface of the optical member PS₁ opposes the light source 30z₁ and the light receiving device 30z₂.

The encoder 30z emits a laser light Lz from the light source 30z₁ perpendicular to the inclined surface of the optical member PS₁. The laser light Lz enters the optical member PS₁ from the inclined surface, passes therethrough, and impinges the splitting plane BMF provided between the measuring arm 71 and the optical member PS₁. By impinging the splitting plane BMF, the laser light Lz is polarized and split into a reference beam IRz and a measurement beam IBz.

The reference beam IRz is sequentially reflected inside the optical member PS₁ by the −Z side surface (i.e., the reflective surface RP1) of the optical member PS₁, the −Y side surface (i.e., the reflective surface RP2) of the optical member PS₁, and the splitting plane BMF, and then returns to the light receiving device 30z₂.

Moreover, the measurement beam IBz enters the measuring arm 71, transmits through the solid portion while being reflected by the ±Z side surfaces, and heads toward the +Y end of the measuring arm 71. Here, a quarter-wave plate WP (i.e., λ/4 plate) as well as a reflective diffraction grating GRz on the +Y side thereof whose directions of periodicity are oriented in the Z axial directions are provided to the +Y end surface of the measuring arm 71 on the +Z side. The measurement beam IBz transmits through the λ/4 plate WP in the +Y direction and enters the diffraction grating GRz. Thereby, diffracted lights oriented in different directions are generated within the YZ plane (in other words, the measurement beam IBz is diffracted by the diffraction grating GRz in a plurality of directions). For example, the −1st order diffracted light of the plurality of diffracted lights (i.e., the measurement beam IBz diffracted in the −1st order direction) transmits through the λ/4 plate WP in the −Y direction, transmits through the solid portion while being reflected by the ±Z side surfaces of the measuring arm 71, and heads toward the −Y end of the measuring arm 71. Here, by transmitting through the λ/4 plate WP twice, the polarization directions of the measurement beam IBz are rotated by 90°. Consequently, the measurement beam IBz is reflected by the splitting plane BMF.

The reflected measurement beam IBz transmits through the solid portion while being reflected by the ±Z side surfaces of the measuring arm 71, as before, and heads toward the +Y end of the measuring arm 71. The measurement beam IBz transmits through the λ/4 plate WP in the +Y direction and then impinges the diffraction grating GRz. Thereby, a plurality of diffracted lights is once again generated (i.e., the measurement beam IBz is diffracted in a plurality of directions). For example, the −1st order diffracted light of the plurality of diffracted lights (i.e., the measurement beam IBz diffracted in the −1st order direction) transmits through the λ/4 plate WP in the −Y direction, transmits through the solid portion while being reflected by the ±Z side surfaces of the measuring arm 71, and then heads toward the −Y end of the measuring arm 71. Here, by transmitting through the λ/4 plate WP twice, the polarization directions of the measurement beam IBz are further rotated by 90°. Consequently, the measurement beam IBz transmits through the splitting plane BMF.

The transmitted measurement beam IBz is coaxially combined with the reference beam IRz and then returns to the light receiving device 30z₂ together with the reference beam IRz. Inside the light receiving device 30z₂, the polarization directions of the reference beam IRz and the measurement beam IBz are aligned by the polarizer and thereby transition to an interfered beam. This interfered beam is detected by the photodetector (not shown) and then converted to an electrical signal that corresponds to its intensity.

Here, if the measuring arm 71 flexes and its +Y end surface (i.e., tip surface) is displaced in the Z axial directions, then the phase of the measurement beam IBz shifts with respect to the phase of the reference beam IRz in accordance with that displacement. Thereby, the intensity of the interfered beam changes. The change in the intensity of the interfered beam is supplied to the main control apparatus 20 as displacement information that represents the displacement of the tip surface of the measuring arm 71 in the Z axial directions. Furthermore, although the flexure of the measuring arm 71 changes the optical path length of the measurement beam IBz and, attendant therewith, the phase of the measurement beam IBz can shift, the measuring system 30′ is designed such that the degree of that phase shift is sufficiently smaller than the degree of the phase shift that accompanies Z displacement of the tip surface of the measuring arm 71.

An optical member PS₂ is fixed to the −Y end part of the measuring arm 71 on the −Z side (i.e., on the −Z side of the optical member PS₁). The optical member PS₂ is a hexahedral member with the shape of the optical member PS₁ rotated by 90° around an axis parallel to the Y axis such that its inclined surface comes to the near side. Namely, the optical member PS₂ is a hexahedral member that has a trapezoidal shape in an XY cross section (i.e., a cross section that is parallel to the Z axis) and a prescribed length in the Z axial directions. The inclined surface of the optical member PS₂ opposes the light source 30x₁ and the light receiving device 30x₂.

In addition, the quarter-wave plate WP (i.e., λ/4 plate) and a reflective diffraction grating GRx on the +Y side thereof whose directions of periodicity are oriented in the X axial directions are provided to the +Y end surface of the measuring arm 71 on the −Z side.

The encoder 30x emits a laser light Lx from the light source 30x₁ perpendicular to the inclined surface of the optical member PS2. The laser light Lx enters the optical member PS2 from the inclined surface, passes therethrough, and impinges the splitting plane BMF. By impinging the splitting plane BMF, the laser light Lx is polarized and split into a reference beam IRx and a measurement beam IBx.

Furthermore, like the reference beam IRz discussed above, the reference beam IRx is sequentially reflected inside the optical member PS2 by the −X side reflective surface of the optical member PS2, the −Y side reflective surface of the optical member PS2, and the splitting plane BMF, and then returns to the light receiving device 30x2.

Moreover, the measurement beam IBx enters the measurement arm 71, transits the same optical path as the measurement beam IBz discussed above (i.e., an optical path within the XY plane), is coaxially combined with the reference beam IRx, and then returns to the light receiving device 30x2 together with the reference beam IRx. Inside the light receiving device 30x2, the polarization directions of the reference beam IRx and the measurement beam IBx are aligned by the polarizer and thereby transition to an interfered beam. This interfered beam is detected by the photodetector (not shown) and then converted to an electrical signal that corresponds to its intensity.

Here, if the measuring arm 71 flexes and its +Y end surface (i.e., tip surface) is displaced in the X axial directions, then the phase of the measurement beam IBx shifts with respect to the phase of the reference beam IRx in accordance with that displacement. Thereby, the intensity of the interfered beam changes. The change in the intensity of the interfered beam is supplied to the main control apparatus 20 as displacement information that represents the displacement of the tip surface of the measuring arm 71 in the X axial directions. Furthermore, although the flexure of the measuring arm 71 changes the optical path length of the measurement beam IBx and, attendant therewith, the phase of the measurement beam IBx can shift, the measuring system 30′ is designed such that the degree of that phase shift is sufficiently smaller than the degree of the phase shift that accompanies X displacement of the tip surface of the measuring arm 71.

Based on the displacement information in the Z axial and X axial directions of the measurement arm 71, which is supplied by the encoders 30z, 30x, respectively, the main control apparatus 20 derives the inclination angles of the optical axes of the heads 77x, 77ya, 77yb provided in the vicinity of the measurement arm 71 with respect to the Z axis and the distances between each of the heads 77x, 77ya, 77yb and the grating RG, derives the measurement error of each of the heads 77x, 77ya, 77yb of the encoder system 73 based on the inclination angles, the distances, and the correction information, which is discussed below, and uses the derived measurement errors to correct the measurement values.

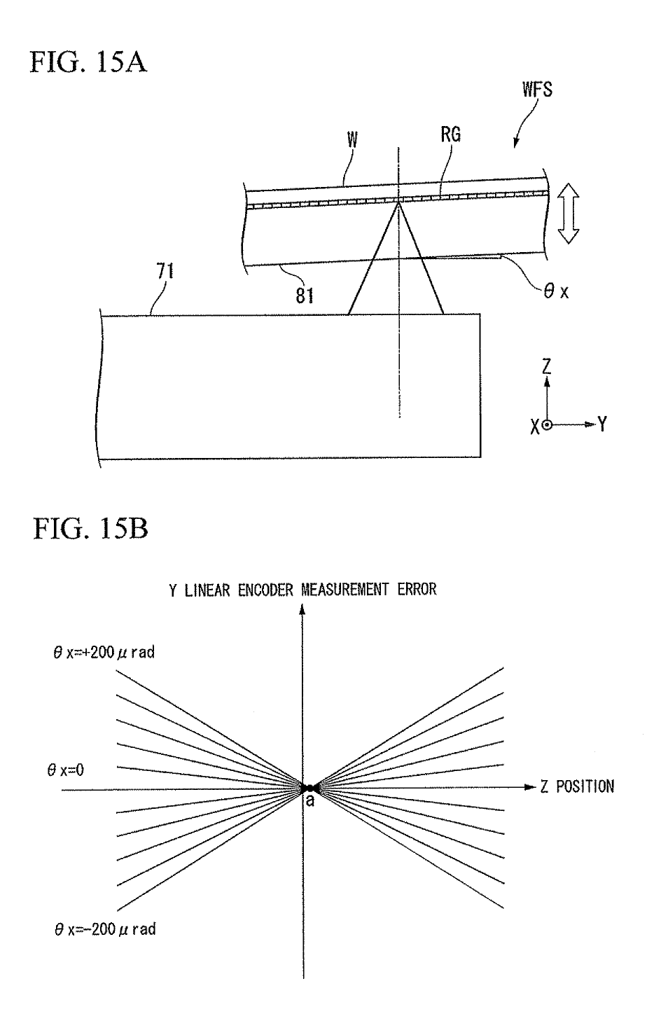

The main control apparatus 20 pregenerates the correction information of the encoder system 73 corresponding to the surface position of the tip surface of the measuring arm 71 using a technique identical to that disclosed in, for example, PCT International Publication No. WO2008/026732 discussed above. Namely, as shown in simplified form in FIG. 15A, the main control apparatus 20 drives the fine motion stage WFS in the state wherein the measuring arm 71 opposes the grating RG, and fixes the amount of pitching θx to, for example, 200 μrad (and zeros the amount of yawing θz and the amount of rolling θy). Next, the main control apparatus 20 drives the fine motion stage WFS within a prescribed range (for example, −100 to +100 μm) in the Z axial directions and, during that drive, stores measurement values of the Y head 77ya (i.e., the Y linear encoder 73ya) and the Y head 77yb (i.e., the Y linear encoder 73yb) with a prescribed sampling interval in a memory apparatus 42 (refer to FIG. 5). Furthermore, the main control apparatus 20 drives the fine motion stage WFS such that the amount of pitching θx decreases to a prescribed amount, for example, 40 μrad, and at each sampled position drives the fine motion stage WFS within a prescribed range in the Z axial directions; furthermore, during each drive, the measurement values of the Y heads 77ya and 77yb are successively captured with a prescribed sampling interval and stored in the memory apparatus 42. The main control apparatus 20 uses the above process to plot the data in the memory apparatus 42 in a two dimensional coordinate system wherein the abscissa represents the Z position and the ordinate represents the measurement values of the heads; furthermore, plot points corresponding to the same amount of pitching θx are sequentially connected, the abscissa in the longitudinal directions is shifted such that the line corresponding to the zero amount of pitching θx (i.e., the center lateral line) passes through the origin, and thereby the graph like the one shown in FIG. 15B is created for each of the Y heads 77ya and 77yb. The values along the ordinate in the graph shown in FIG. 15B indicates the measurement error of the Y head 77ya (or 77yb) at each Z position for each amount of pitching θx. The main control apparatus 20 stores in the memory apparatus 42 as the correction information related to each of the Y heads 77ya, 77yb the functions corresponding to the graph in FIG. 15B, namely, the relationships among the amount of pitching θx of the fine motion stage WFS, the Z position of the fine motion stage WFS, and the measurement error of the Y head 77ya (or 77yb). Alternatively, the main control apparatus 20 may convert the points on the graph shown in FIG. 15B to table data and store such in the memory apparatus 42 as the correction information related to each of the Y heads 77ya, 77yb.

Next, using the same procedure as the case wherein the amount of pitching θx was changed as discussed above, the main control apparatus 20 sequentially changes the amount of yawing θz of the fine motion stage WFS within a range of −200 to +200 μrad while maintaining both the amount of pitching θx and the amount of rolling θy of the fine motion stage WFS at zero and, at each changed position, drives the fine motion stage WFS in the Z axial directions within a prescribed range, for example, a range of −100 to +100 μm; furthermore, during that driving, the main control apparatus 20 sequentially captures the measurement values of the Y heads 77ya and 77yb at prescribed sampling intervals, converts those values to table data, and stores such in the memory apparatus 42. Furthermore, the measurement error of each of the Y heads 77ya, 77yb when both the amount of pitching θx and the amount of yawing θz are nonzero is defined by the sum of the measurement error that corresponds to the amount of pitching θx and the measurement error that corresponds to the amount of yawing θz.

Using the same procedure as that discussed above, the main control apparatus 20 generates correction information related to the X head 77x (i.e., the X linear encoder 73x) and stores such in the memory apparatus 42. However, when deriving the correction information related to the head 77x, the amount of pitching θx and the amount of rolling θy of the fine motion stage WFS are continuously set to zero, the amount of yawing θz of the fine motion stage WFS is sequentially varied within a range of −200 to +200 μrad and, at each changed position, the fine motion stage WFS is driven in the Z axial directions within a prescribed range, for example, a range of −100 to +100 μm.

Furthermore, in the abovementioned procedure for generating correction information, the state wherein the measuring arm 71 is deformed is reproduced by driving the fine motion stage WFS and, based thereon, the measurement error is measured; however, for example, the correction information may be generated by actually bending the measuring arm 71; in short, this approach makes it possible to reproduce the state wherein the optical axis of each head of the encoder system 73 is tilted with respect to the grating RG.

A measurement error Δy of the Y linear encoder 73y and a measurement error Δx of the X linear encoder 73x explained above are expressed by the functions in equations (1), (2) below, and the main control apparatus 20 calculates the measurement error of the encoder system 73 based on equations (1), (2).

Δy=f(z,θx,θz)=θx(z−a)+θz(z−b) (1)

Δx=g(z,θz)=θz(z−c) (2)

Furthermore, in equation (1) above, a is the Z coordinate of the point at which all straight lines on the graph shown in FIG. 15B intersect, and b is the Z coordinate of the point at which all straight lines on the same graph in FIG. 15B would intersect for the case wherein the amount of yawing is varied in order to acquire the correction information of the Y encoder. In addition, in equation (2) above, c is the Z coordinate of the point at which all straight lines of the same graph shown in FIG. 15B would intersect for the case wherein the amount of yawing is varied in order to acquire the correction information of the X encoder.

In the exposure apparatus 100 of the present embodiment configured as discussed above, when a device is to be fabricated, the main control apparatus 20 first uses the wafer alignment system ALG to detect the second fiducial mark on the measuring plate 86 of the fine motion stage WFS. Next, the main control apparatus 20 uses the wafer alignment system ALG to perform wafer alignment (e.g., enhanced global alignment (EGA) and the like disclosed in, for example, U.S. Pat. No. 4,780,617) and the like. Furthermore, in the exposure apparatus 100 of the present embodiment, the wafer alignment system ALG is disposed spaced apart from the projection unit PU in the Y axial directions, and therefore the encoder system (i.e., the measuring arm) of the fine motion stage position measuring system 70 cannot measure the position of the fine motion stage WFS when wafer alignment is being performed. Accordingly, in the exposure apparatus 100, a second fine motion stage position measuring system (not shown), which comprises a measuring arm configured the same as the measuring arm 71 of the fine motion stage position measuring system 70 discussed above, is provided in the vicinity of the wafer alignment system ALG and is used to measure the position of the fine motion stage within the XY plane during a wafer alignment. However, the present invention is not limited thereto; for example, the wafer alignment may be performed while the position of the wafer W is being measured via the wafer stage position measuring system 16 discussed above. In addition, because the wafer alignment system ALG and the projection unit PU are spaced apart, the main control apparatus 20 converts the array coordinates of each of the shot regions on the wafer W, which were obtained as a result of the wafer alignment, to array coordinates wherein the second fiducial mark serves as a reference.

Furthermore, prior to the start of an exposure, the main control apparatus 20 uses the pair of reticle alignment systems RA₁, RA₂, the pair of first fiducial marks on the measuring plate 86 of the fine motion stage WFS, and the like, all of which were discussed above, to perform a reticle alignment using a procedure identical to that of a regular scanning stepper (e.g., the procedure disclosed in U.S. Pat. No. 5,646,413). Furthermore, based on the results of the reticle alignment and of the wafer alignment (i.e., the array coordinates of each shot region on the wafer W wherein the second fiducial mark serves as a reference), the main control apparatus 20 performs step-and-scan type exposure operations to transfer the pattern of the reticle R to the plurality of shot regions on the wafer W. These exposure operations are performed by repetitively and alternately performing a scanning exposure operation, which synchronously moves the reticle stage RST and the wafer stage WST as discussed above, and an inter-shot movement operation (i.e., stepping), which moves the wafer stage WST to an acceleration start position for exposing a shot region. In this case, the scanning exposure is performed by an immersion exposure. In the exposure apparatus 100 of the present embodiment, during the sequence of exposure operations discussed above, the main control apparatus 20 uses the fine motion stage position measuring system 70 to measure the position of the fine motion stage WFS (i.e., the wafer W) and, based on this measurement result, controls the position of the wafer W. At this time, the main control apparatus 20 controls the position within the XY plane (including θz rotation) of the wafer W while correcting the measurement values of each encoder of the encoder system 73 using equations (1), (2) discussed above, namely, using the correction information stored in the memory apparatus 42.

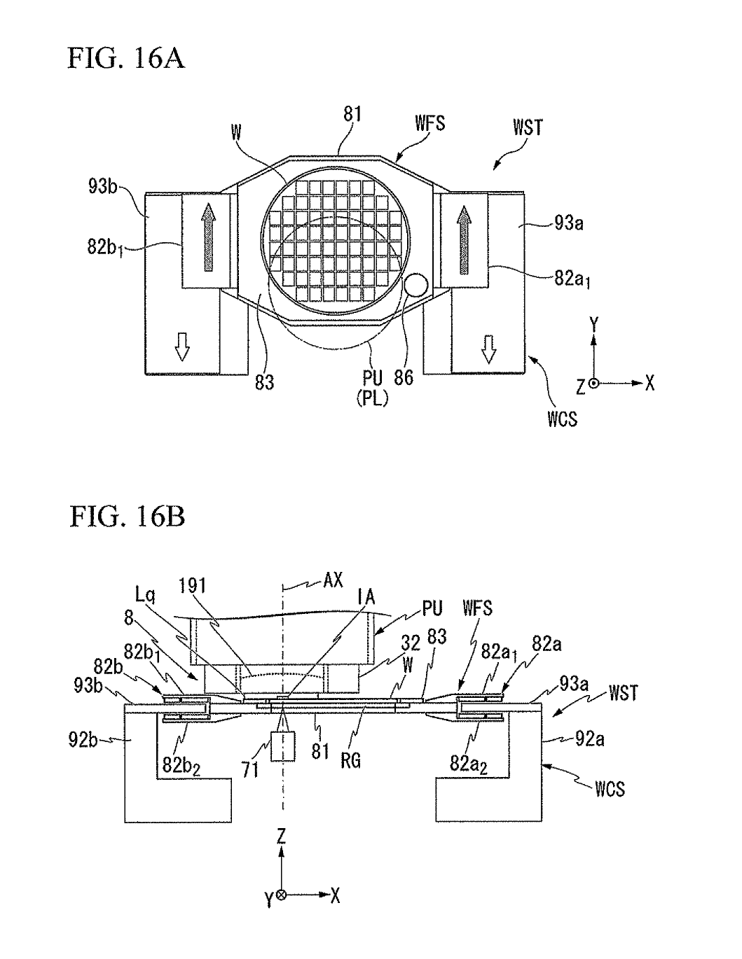

Furthermore, during the scanning exposure operation discussed above, the wafer W must be scanned in the Y axial directions at a high acceleration; however, in the exposure apparatus 100 of the present embodiment, as shown in FIG. 16A, the main control apparatus 20 scans the wafer W in the Y axial directions by driving only the fine motion stage WFS in the Y axial directions (refer to the solid arrows in FIG. 16A; and, as needed, in the directions corresponding to the other five degrees of freedom) without, as a rule, driving the coarse motion stages WCS. This is because to drive the wafer W at high acceleration, it is advantageous to drive the wafer W using only the fine motion stage WFS, which is lighter than the coarse motion stages WCS. In addition, as discussed above, the position measurement accuracy of the fine motion stage position measuring system 70 is higher than that of the wafer stage position measuring system 16, and therefore it is advantageous to drive the fine motion stage WFS during the scanning exposure. Furthermore, during the scanning exposure, the action of the reaction force (refer to the outlined arrows in FIG. 16A) generated by the drive of the fine motion stage WFS drives the coarse motion stages WCS in a direction opposite that of the fine motion stage WFS. Namely, the coarse motion stages WCS function as countermasses and conserve the momentum of the system that constitutes the entire wafer stage WST, and thereby the center of gravity does not move; therefore, the problem wherein, for example, a bias load acts on the base plate 12 owing to the drive of the fine motion stage WFS during a scan does not arise.

Moreover, when the inter-shot movement operation (i.e., stepping) is performed in the X axial directions, the fine motion stage WFS can move in the X axial directions by only a small amount; therefore, as shown in FIG. 16B, the main control apparatus 20 moves the wafer W in the X axial directions by driving the coarse motion stages WCS in the X axial directions.

According to the exposure apparatus 100 of the present embodiment as explained above, the main control apparatus 20 uses the encoder system 73 of the fine motion stage position measuring system 70 comprising the measuring arm 71, which is disposed opposing the grating RG disposed in the fine motion stage WFS, to measure the position of the fine motion stage WFS within the XY plane. In this case, the irradiation point on the grating RG of each measurement beam, which emerges from the measuring arm 71, of each head of the encoder system 73 and the laser interferometer system 75—such systems constituting the fine motion stage position measuring system 70—coincides with the center (i.e., the exposure position) of the irradiation area IA (i.e., the exposure area) of the illumination light IL radiated to the wafer W. Accordingly, the main control apparatus 20 can measure the position of the fine motion stage WFS with high accuracy without being affected by so-called Abbé error. In addition, disposing the measuring arm 71 directly below the grating RG makes it possible to greatly shorten the in-air optical path lengths of the measurement beams of the heads of the encoder system 73, which in turn reduces the effects of air turbulence and makes it possible to measure the position of the fine motion stage WFS with high accuracy.

Furthermore, in the exposure apparatus 100 of the present embodiment, the main control apparatus 20 drives the fine motion stage WFS via the fine motion stage drive system 52 based on: the measurement result of the fine motion stage position measuring system 70; and the measurement result of the measuring system 30, which measures the change in the shape of the measuring arm 71 using the laser interferometers 30a-30d. In this case, even if the various vibrations generated in the exposure apparatus 100 transmit to the measuring arm 71, the measuring arm 71 itself vibrates, and thereby the irradiation points on the grating RG for the measurement beams of the heads of the encoder system 73 become unstable, the main control apparatus 20 can still drive the fine motion stage WFS based on the measurement values of the heads of the encoder system 73 that have been corrected by the correction information corresponding to the measurement results of the measuring system 30. Accordingly, the position of the fine motion stage WFS can be measured with higher accuracy. In addition, in the measuring system 30, changes in the shape of the measuring arm 71 are measured using the laser interferometers, which cause the length measurement beams to travel through the interior of the measuring arm 71, which is made of glass, and therefore changes in the shape of the measuring arm 71 can be measured with high accuracy virtually unaffected by air turbulence.

In addition, according to the exposure apparatus 100 of the present embodiment, the fine motion stage WFS can be accurately driven, which makes it possible to accurately drive the wafer W mounted on the fine motion stage WFS synchronously with the reticle stage RST (i.e., the reticle R) and thereby to accurately transfer the pattern on the reticle R to the wafer W via a scanning exposure.

Furthermore, the abovementioned embodiment explained a case wherein the arm member that constitutes the fine motion stage position measuring system 70 is made entirely of, for example, glass and comprises the measuring arm 71, wherethrough light can travel, but the present invention is not limited thereto. For example, the arm member may have a hollow structure wherein at least the portions wherethrough each of the length measurement beams and the laser beams travel, which was discussed above, may be formed as solid members wherethrough light can travel, and the other portions may be formed as, for example, members that do not transmit light. In addition, as long as the measurement beams can be radiated from the portion that opposes the grating, for example, the arm member may be configured such that the light source, the photodetector, and the like are built into the tip part of the arm member. In this case, the measurement beams of the encoders do not have to travel through the interior of the arm member, which may be formed as a member that transmits only the light of the portion wherethrough at least the length measurement beams of the laser interferometers that constitute the measuring system 30 travel. Furthermore, the arm member does not have to have a prismatic shape, and may have, for example, a circular columnar shape in a cross section. In addition, the cross section does not have to be a uniform cross section.

In addition, in the abovementioned embodiment, length measurement beams for measuring changes in the shape of the measuring arm 71 are radiated to positions that correspond to four corner parts of the tip surface of the measuring arm 71, but the present invention is not limited thereto; for example, the length measurement beams may be radiated to three points that are not disposed along the same straight line on the tip surface of the measuring arm 71. In this case, too, changes in the shape of the measuring arm 71 can be measured based on changes in the surface position of the tip surface of the measuring arm 71.

In addition, the abovementioned embodiment explained an exemplary case wherein the encoder system 73 comprises the X head 77x and the pair of Y heads 77ya, 77yb, but the present invention is not limited thereto; for example, one or two two-dimensional heads (i.e., 2D heads), whose measurement directions are in two directions, namely, the X axial directions and the Y axial directions, may be provided. If two 2D heads are provided, then their detection points may be two points that are equidistantly spaced apart from the center of the exposure position on the grating RG in the X axial directions.

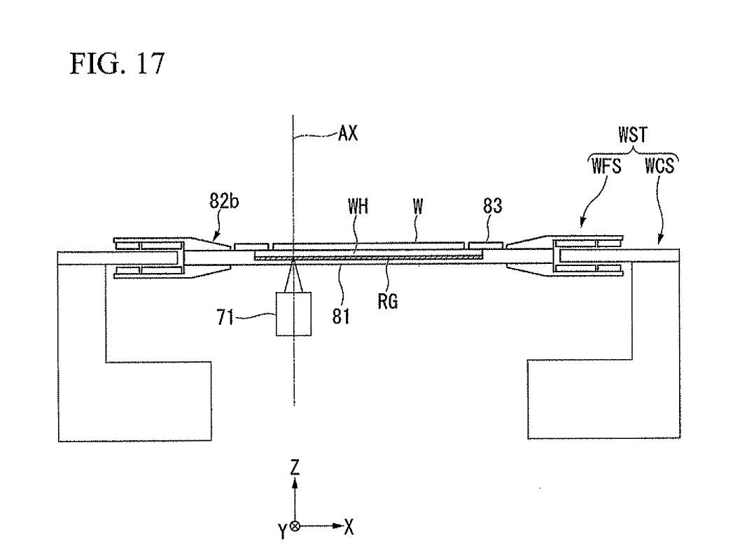

Furthermore, in the abovementioned embodiment, the grating RG is disposed on the upper surface of the fine motion stage WFS, namely, on the surface that opposes the wafer W, but the present invention is not limited thereto; for example, as shown in FIG. 17, the grating may be formed in the lower surface of the wafer holder WH, which holds the wafer W. In such a case, even if the wafer holder WH expands during an exposure or if a mounting position deviates with respect to the fine motion stage WFS, it is possible to track this deviation and still measure the position of the wafer holder WH (i.e., the wafer W). In addition, the grating may be disposed on the lower surface of the fine motion stage WFS; in such a case, the measurement beams radiated from the encoder heads would not travel through the interior of the fine motion stage WFS and, therefore, the fine motion stage would not have to be a solid member wherethrough the light can transmit, the interior of the fine motion stage could have a hollow structure wherein piping, wiring, and the like could be disposed, and thereby the fine motion stage could be made more lightweight.

Furthermore, the abovementioned embodiment explained an exemplary case wherein the wafer stage WST is a coarse/fine motion stage that combines the coarse motion stages WCS and the fine motion stage WFS, but the present invention is not limited thereto.

In addition, the drive mechanism that drives the fine motion stage WFS with respect to the coarse motion stages WCS is not limited to the one explained in the abovementioned embodiment. For example, in the abovementioned embodiment, the coils that drive the fine motion stage WFS in the Y axial directions also function as the coils that drive the fine motion stage WFS in the Z axial directions, but the present invention is not limited thereto; for example, actuators (i.e., linear motors) that drive the fine motion stage in the Y axial directions and actuators that drive, namely, levitate, the fine motion stage in the Z axial directions may be separately provided. In such a case, because a constant levitational force can be applied continuously to the fine motion stage, the position of the fine motion stage in the Z axial directions is stable.

Furthermore, in the abovementioned embodiment, the coarse motion stages WCS support the fine motion stage WFS noncontactually by virtue of the action of the Lorentz's forces (i.e., electromagnetic forces), but the present invention is not limited thereto; for example, a vacuum boosted aerostatic bearing and the like may be provided to the fine motion stage WFS, and the coarse motion stages WCS may levitationally support the fine motion stage WFS. In addition, in the abovementioned embodiment, the fine motion stage WFS can be driven in directions corresponding to a total of six degrees of freedom, but the present invention is not limited thereto; for example, any number of degrees of freedom is acceptable as long as the fine motion stage WFS can move at least within a two dimensional plane that is parallel to the XY plane. In addition, the fine motion stage drive system 52 is not limited to the moving magnet type discussed above and may be a moving coil type. Furthermore, the coarse motion stages WCS may support the fine motion stage WFS contactually. Accordingly, the fine motion stage drive system 52 that drives the fine motion stage WFS with respect to the coarse motion stages WCS may comprise a combination of, for example, a rotary motor and a ball screw (or a feed screw).

Furthermore, the abovementioned embodiment explained a case wherein the exposure apparatus 100 is a liquid immersion type exposure apparatus, but the present invention is not limited thereto; for example, the present invention can be suitably adapted also to a dry type exposure apparatus that exposes the wafer W without transiting any liquid (i.e., water).

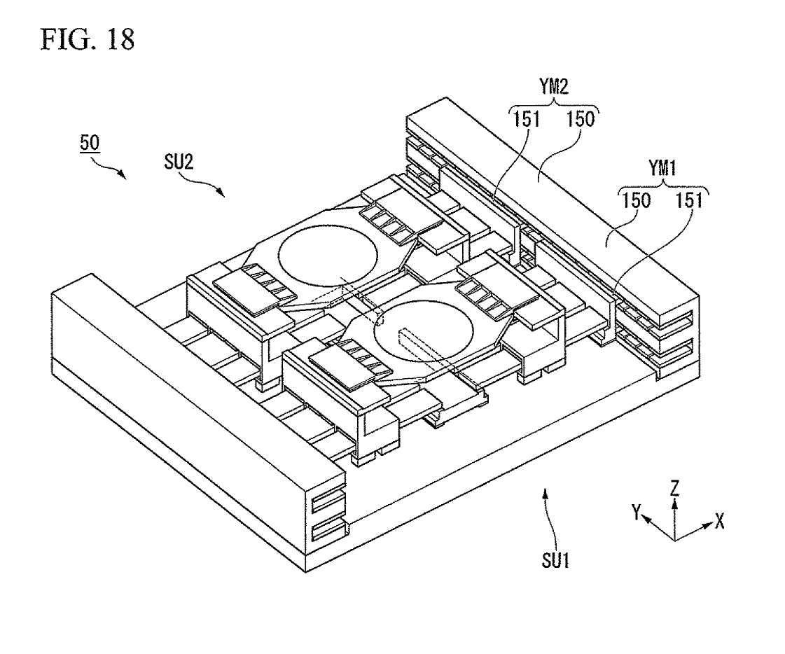

In addition, the abovementioned embodiment explained a single stage type exposure apparatus wherein the stage apparatus 50 comprises one stage unit SU, but the present invention is not limited thereto; for example, as shown in FIG. 18, the present invention can be suitably adapted also to a twin stage type exposure apparatus that comprises two stage units SU1, SU2. The modified example in FIG. 18 shows one embodiment of a configuration wherein two Y linear motors, namely, Y linear motors YM1, YM2, share one stator 150, but the present invention is not limited thereto; for example, various configurations can be adopted. In the case wherein the stage apparatus 50 is a twin stage type, two of the fine motion stage position measuring systems 70, corresponding to the two stage units SU1, SU2, may be provided at different positions within the XY plane. Adapting the present invention to a twin stage type exposure apparatus makes it possible to measure, with high accuracy, the positions of the two fine motion stages WFS, which are held by the two stage units SU1, SU2, within the XY plane and, thereby, to drive the fine motion stages WFS with high accuracy. Furthermore, the twin stage type exposure apparatus can also be a liquid immersion type as discussed above.

Furthermore, the abovementioned embodiment explained a case wherein the present invention is adapted to a scanning stepper, but the present invention is not limited thereto; for example, the present invention may also be adapted to a static type exposure apparatus, such as a stepper. Unlike the case wherein encoders measure the position of a stage whereon an object to be exposed is mounted and the position of the stage is measured using an interferometer, it is possible, even in the case of a stepper and the like, to reduce the generation of position measurement errors owing to air turbulence to virtually zero, and therefore to position the stage with high accuracy based on the measurement values of the encoder; as a result, a reticle pattern can be transferred to an object with high accuracy. In addition, the present invention can also be adapted to a step-and-stitch type reduction projection exposure apparatus that stitches shot regions together.

In addition, the projection optical system PL in the exposure apparatus 100 of the embodiment mentioned above is not limited to a reduction system and may be a unity magnification system or an enlargement system; furthermore, the projection optical system PL is not limited to a dioptric system and may be a catoptric system or a catadioptric system; in addition, the image projected thereby may be either an inverted image or an erect image.

In addition, the illumination light IL is not limited to ArF excimer laser light (with a wavelength of 193 nm), but may be ultraviolet light, such as KrF excimer laser light (with a wavelength of 248 nm), or vacuum ultraviolet light, such as F₂ laser light (with a wavelength of 157 nm). For example, as disclosed in U.S. Pat. No. 7,023,610, higher harmonics may also be used as the vacuum ultraviolet light by utilizing, for example, an erbium (or erbium-ytterbium) doped fiber amplifier to amplify single wavelength laser light in the infrared region or the visible region that is generated from a DFB semiconductor laser or a fiber laser, and then using a nonlinear optical crystal for wavelength conversion to convert the output laser light to ultraviolet light.

In addition, the illumination light IL of the exposure apparatus 100 in the abovementioned embodiment is not limited to light with a wavelength of 100 nm or greater, and, of course, light with a wavelength of less than 100 nm may be used. For example, the present invention can be adapted to an EUV exposure apparatus that uses extreme ultraviolet (EUV) light in the soft X-ray region (e.g., light in a wavelength band of 5-15 nm). In addition, the present invention can also be adapted to an exposure apparatus that uses a charged particle beam, such as an electron beam or an ion beam.

In addition, in the embodiment discussed above an optically transmissive mask (i.e., a reticle) wherein a prescribed shielding pattern (or a phase pattern or dimming pattern) is formed on an optically transmissive substrate is used; however, instead of such a reticle, an electronic mask—including variable shaped masks, active masks, and digital micromirror devices (DMDs), which are also called image generators and are one type of non-light emitting image display devices (i.e., spatial light modulators)—may be used wherein a transmissive pattern, a reflective pattern, or a light emitting pattern is formed based on electronic data of the pattern to be exposed, as disclosed in, for example, U.S. Pat. No. 6,778,257. In the case wherein a variable shaped mask is used, the stage whereon the wafer, a glass plate, or the like is mounted is scanned with respect to the variable shaped mask, and therefore effects equivalent to those of the abovementioned embodiment can be obtained by using the encoder system and a laser interferometer system to measure the position of the stage.

In addition, by forming interference fringes on the wafer W as disclosed in, for example, PCT International Publication No. WO2001/035168, the present invention can also be adapted to an exposure apparatus (i.e., a lithographic system) that forms a line-and-space pattern on the wafer W.

Furthermore, the present invention can also be adapted to, for example, an exposure apparatus that combines the patterns of two reticles onto a wafer via a projection optical system and double exposes, substantially simultaneously, a single shot region on the wafer using a single scanning exposure, as disclosed in, for example, U.S. Pat. No. 6,611,316.

Furthermore, in the abovementioned embodiment, the object whereon the pattern is to be formed (i.e., the object to be exposed by being irradiated with an energy beam) is not limited to a wafer, and may be a glass plate, a ceramic substrate, a film member, or some other object such as a mask blank.

The application of the exposure apparatus 100 is not limited to an exposure apparatus for fabricating semiconductor devices, but can be widely adapted to, for example, an exposure apparatus for fabricating liquid crystal devices, wherein a liquid crystal display device pattern is transferred to a rectangular glass plate, as well as to exposure apparatuses for fabricating organic electroluminescent displays, thin film magnetic heads, image capturing devices (e.g., CCDs), micromachines, and DNA chips. In addition to fabricating microdevices like semiconductor devices, the present invention can also be adapted to an exposure apparatus that transfers a circuit pattern to a glass substrate, a silicon wafer, or the like in order to fabricate a reticle or a mask used by a light exposure apparatus, an EUV exposure apparatus, an X-ray exposure apparatus, an electron beam exposure apparatus, and the like.

Furthermore, the stage apparatus of the present invention is not limited in its application to the exposure apparatus and can be widely adapted to any of the substrate processing apparatuses (e.g., a laser repair apparatus, a substrate inspecting apparatus, and the like) or to an apparatus that comprises a movable stage such as a sample positioning apparatus in a precision machine, or a wire bonding apparatus.

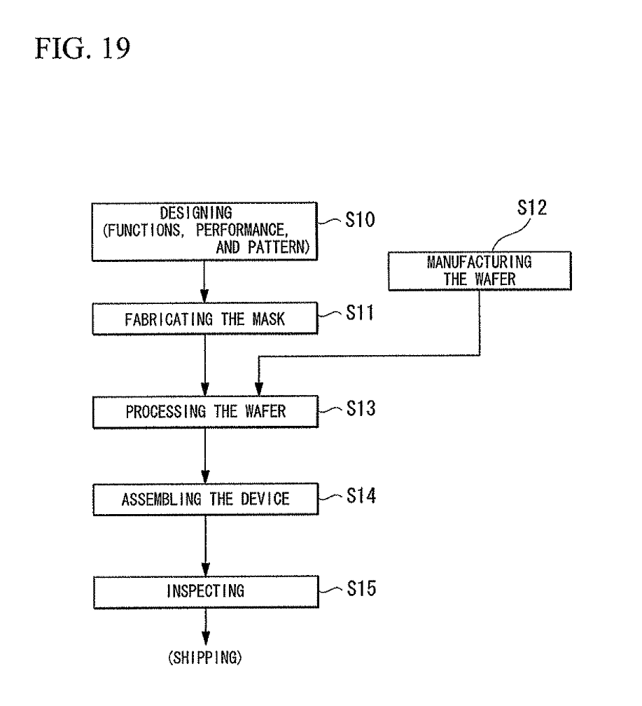

The following text explains an embodiment of a method of fabricating microdevices using the exposure apparatus and the exposing method according to the embodiments of the present invention in a lithographic process. FIG. 19 depicts a flow chart of an example of fabricating a microdevice (i.e., a semiconductor chip such as an IC or an LSI; a liquid crystal panel; a CCD; a thin film magnetic head; a micromachine; and the like).

First, in a step S10 (i.e., a designing step), the functions and performance of the microdevice (e.g., the circuit design of the semiconductor device), as well as the pattern for implementing those functions, are designed. Next, in a step S11 (i.e., a mask fabricating step), the mask (i.e., the reticle), wherein the designed circuit pattern is formed, is fabricated. Moreover, in a step S12 (i.e., a wafer manufacturing step), the wafer is manufactured using a material such as silicon.

Next, in a step S13 (i.e., a wafer processing step), the actual circuit and the like are formed on the wafer by, for example, lithographic technology (discussed later) using the mask and the wafer that were prepared in the steps S10-S12. Then, in a step S14 (i.e., a device assembling step), the device is assembled using the wafer that was processed in the step S13. In the step S14, processes are included as needed, such as the dicing, bonding, and packaging (i.e., chip encapsulating) processes. Lastly, in a step S15 (i.e., an inspecting step), inspections are performed, for example, an operation verification test and a durability test of the microdevice fabricated in the step S14. Finishing such processes completes the fabrication of the microdevice, which is then shipped.

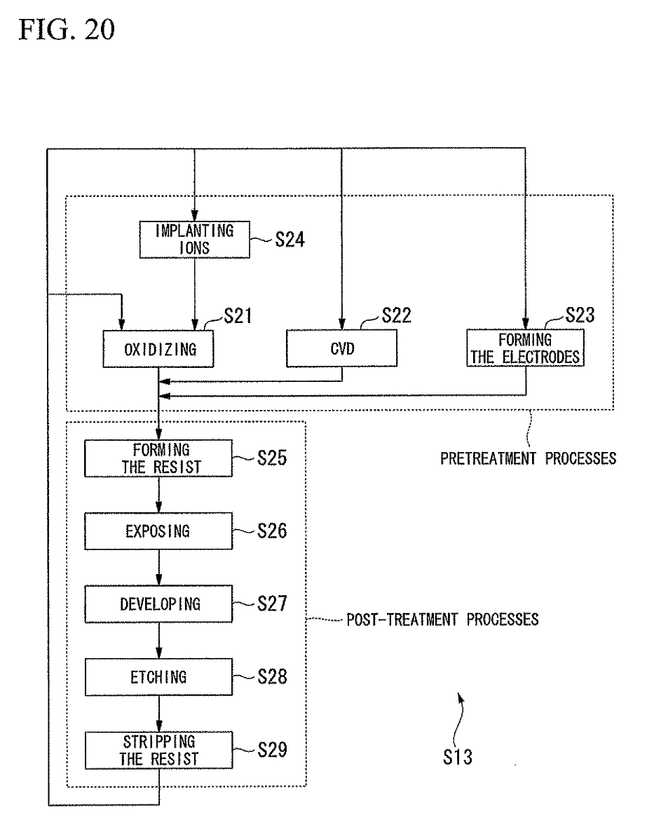

FIG. 20 depicts one example of the detailed process of the step S13 for the case of a semiconductor device.

In a step S21 (i.e., an oxidizing step), the front surface of the wafer is oxidized. In a step S22 (i.e., a CVD step), an insulating film is formed on the front surface of the wafer. In a step S23 (i.e., an electrode forming step), an electrode is formed on the wafer by vacuum deposition. In a step S24 (i.e., an ion implanting step), ions are implanted in the wafer. The above steps S21-S24 constitute the pretreatment processes of the various stages of wafer processing and are selectively performed in accordance with the processes needed in the various stages.

When the pretreatment processes discussed above in each stage of the wafer process are complete, post-treatment processes are performed as described below. In the post-treatment processes, the wafer is first coated with a photosensitive agent in a step S25 (i.e., a resist forming step). Continuing, in a step S26 (i.e., an exposing step), the circuit pattern of the mask is transferred onto the wafer by the lithography system (i.e., the exposure apparatus) and the exposing method explained above. Next, in a step S27 (i.e., a developing step), the exposed wafer is developed; further, in a step S28 (i.e., an etching step), the uncovered portions are removed by etching, excluding the portions where the resist remains. Further, in a step S29 (i.e., a resist stripping step), etching is finished and the resist that is no longer needed is stripped. Circuit patterns are superposingly formed on the wafer by repetitively performing the pretreatment and post-treatment processes.

As explained above, the moving body apparatus and the moving body driving method of the present invention are suitable for driving a moving body within a prescribed plane. In addition, the exposure apparatus and the exposing method of the present invention are suitable for forming a pattern on an object by radiating an energy beam thereto. In addition, the device fabricating method of the present invention is suitable for fabricating electronic devices.

A drive system according to the above drives the moving body based on: measurement results of the first measuring system that measures the position of the moving body within a prescribed plane by radiating the first measurement beam from the arm member to a measurement surface disposed in a surface of the moving body that is substantially parallel to the prescribed plane; and measurement results of the second measuring system that uses the optical interferometric measuring system to measure a change in the shape of the arm member. In such a case, the drive system can use the measurement results of the second measuring system to correct measurement error, owing to a change in the shape of the arm member, included in the measurement results of the first measuring system. Accordingly, the moving body can be driven with good accuracy.

Because the above makes it possible to drive the moving body, which constitutes a moving body apparatus, with good accuracy, the pattern can be formed on the object with good accuracy by driving the object mounted on this moving body with good accuracy and radiating the energy beam to the object with a patterning apparatus.

In a driving step according to the above, the moving body is driven based on: measurement results of the first measuring step that measures the position of the moving body within a prescribed plane by radiating the first measurement beam from the arm member to a measurement surface disposed in a surface of the moving body that is substantially parallel to the prescribed plane; and measurement results of the second measuring step that uses the optical interferometric measuring system to measure a change in the shape of the arm member. In such a case, in the driving step, the measurement results of the second measuring step can be used to correct measurement error, owing to a change in the shape of the arm member, included in the measurement results of the first measuring step. Accordingly, the moving body can be driven with good accuracy.

Because the above makes it possible to drive the moving body with good accuracy, the pattern can be formed on the object with good accuracy by driving the object mounted on this moving body with good accuracy and radiating the energy beam to the object.

Because the above makes it possible to drive the second moving bodies with high accuracy during a scanning exposure, the object can be exposed with high accuracy.

1. A stage apparatus, comprising:
a first moving body, which comprises guide members that extend in a first axial direction, that moves in a second axial direction, which is substantially orthogonal to the first axial direction;
two second moving bodies, which are provided such that they are capable of moving independently in the first axial direction along the guide members, that move in the second axial direction together with the guide members by the movement of the first moving body;
a holding member, which holds an object and is movably supported by the two second moving bodies within a two dimensional plane that includes at least the first axial direction and the second axial direction, whereon a measurement surface is disposed in a plane that is substantially parallel to the two dimensional plane;
a first measuring system that comprises an arm member—which has a longitudinal direction oriented in the first axial direction, is disposed such that at least a first end part and a second end part opposes the measurement surface, and at least part of which is a solid part wherethrough light can travel—and that measures the position of the holding member at least within the two dimensional plane by radiating at least one first measurement beam from the arm member to the measurement surface and receiving the light of the first measurement beam from the measurement surface;
a second measuring system, which comprises an optical interferometric measuring system that radiates at least one second measurement beam from the second end part of the arm member to a detection surface provided to the first end part of the arm member via the solid part and receives light of the second measurement beam from the detection surface, that measures a change in the shape of the arm member based on a measurement result of the optical interferometric measuring system; and
a drive system, which drives the holding member based on the outputs of the first measuring system and the second measuring system.

2. A stage apparatus according to claim 1, wherein
the detection surface is a reflective surface; and
the optical interferometric measuring system measures the optical path length of each second measurement beam of the plurality of second measurement beams by radiating the plurality of second measurement beams parallel to the first axial direction to the detection surface and receiving the reflected beams from the detection surface.

3. A stage apparatus according to claim 2, wherein
the arm member has a rectangular shape in a cross section orthogonal to the first axis; and
the optical interferometric measuring system causes the plurality of second measurement beams from positions corresponding to at least four corner parts of the detection surface to enter the interior of the solid part.

4. A stage apparatus according to claim 2, wherein
the optical interferometric measuring system uses a common reference beam to measure the optical path lengths of the plurality of second measurement beams.

5. A stage apparatus according to claim 1, wherein
a grating is provided to the detection surface; and
the optical interferometric measuring system measures the displacement of the detection surface in the direction of periodicity of the grating by receiving diffracted light from the detection surface.

6. A stage apparatus according to claim 5, wherein
the detection surface comprises two diffraction gratings whose directions of periodicity are oriented in two orthogonal directions within the detection surface; and the optical interferometric measuring system measures the displacement of the detection surface in the two directions by radiating two measurement beams, which correspond to the two diffraction gratings and serve as the second measurement beams, and receiving diffracted lights of the two measurement beams from the detection surface.

7. A stage apparatus according to claim 1, wherein
the first measurement beam travels parallel to the first axial direction through the interior of the arm member; and
the arm member comprises an optical system, which directs the first measurement beam that travels through the interior of the arm member toward the measurement surface in the vicinity of the first end part.

8. A stage apparatus according to claim 1, wherein
the grating is formed in the measurement surface; and
the first measuring system receives the diffracted light of the first measurement beam from the measurement surface.

9. A stage apparatus according to claim 8, wherein
the optical system causes the diffracted light from the measurement surface or a combined light of a plurality of the diffracted lights from the measurement surface to travel parallel to the first axial direction through the interior of the arm member.

10. A stage apparatus according to claim 8, wherein
the measurement surface comprises first and second diffraction gratings whose directions of periodicity are oriented in directions parallel to the first axial direction and the second axial direction, which are orthogonal within a plane that is substantially parallel to the prescribed plane; and
the first measuring system measures the position of the holding member in the first axial direction and the second axial direction by radiating a first axial direction measurement beam and a second axial direction measurement beam, which serve as the first measurement beams and correspond to the first and second diffraction gratings, from the arm member to the measurement surface and receiving the diffracted lights of the first axial direction measurement beam and the second axial direction measurement beam from the measurement surface.

11. A stage apparatus according to claim 10, wherein
the first measuring system radiates at least two measurement beams, which serve as the first axial direction measurement beams and whose irradiation points on the first diffraction grating are different in the second axial direction, to the first diffraction grating.

12. A stage apparatus according to claim 11, wherein
the at least two measurement beams and the second axial direction measurement beam are each radiated to irradiation points on the measurement surface along a straight line parallel to the second axial direction.

13. A stage apparatus according to claim 1, wherein
an emergent end part of the arm member, wherefrom the first measurement beam emerges and travels toward the measurement surface, opposes the measurement surface in the range of motion of the holding member.

14. A stage apparatus according to claim 1, further comprising:
a third measuring system, which comprises an optical interferometric distance measuring instrument that measures the tilt of the moving body with respect to the two dimensional plane by radiating a plurality of third measurement beams to the moving body and receiving the reflected beams thereof;
wherein,
the drive system drives the holding member based on the outputs of the first measuring system, the second measuring system, and the third measuring system.

15. An exposure apparatus that forms a pattern on an object by radiating an energy beam, comprising:
a stage apparatus according to claim 1, wherein the object is mounted on the holding member; and
a patterning apparatus, which radiates the energy beam to the object mounted on the holding member.

16. An exposure apparatus according to claim 15, wherein
a measurement center, which is the center of the irradiation point of the first measurement beam radiated from the first measuring system to the measurement surface, coincides with an exposure position that is the center of an irradiation area of the energy beam radiated to the object.

17. An exposure apparatus according to claim 15, wherein
the holding member is a solid member wherethrough the first measurement beam can travel;
the measurement surface is formed in a first surface, which opposes the object, in a plane of the holding member that is substantially parallel to the prescribed plane; and the arm member opposes a second surface, which is opposite to the first surface.

18. A device fabricating method, comprising:
exposing an object using an exposure apparatus according to claim 15; and
developing the exposed object.

19. A driving method that moves a holding member, which holds an object, within a two dimensional plane that includes a first axial direction and a second axial direction orthogonal to the first axial direction, the method comprising:
moving a first moving body, which comprises guide members that extend in the first axial direction, in the second axial direction;
moving two second moving bodies, which are provided such that they are capable of moving independently in the first axial direction along the guide members, in the second axial direction together with the guide members by the movement of the first moving body;
supporting a holding member, which holds the object, with the two second moving bodies, synchronously moves the two moving bodies along the guide members, and moves the holding member in the first axial direction;
measuring the position of the moving body at least within the two dimensional plane by radiating at least one first measurement beam from the arm member—which has a longitudinal direction oriented in the first axial direction, is disposed such that at least a first end part and a second end part opposes the measurement surface, and at least part of which is a solid part wherethrough light can travel—to the measurement surface disposed on the holding member along a surface that is substantially parallel to the two dimensional plane, and receiving the light of the first measurement beam from the measurement surface;
measuring a change in the shape of the arm member by radiating at least one second measurement beam from the second end part of the arm member to a detection surface provided to the first end part of the arm member via the solid part and receiving light of the second measurement beam from the detection surface; and
driving the holding member based on the measurement result of the position and the change in the shape.

20. A driving method according to claim 19, wherein
a grating is formed in the measurement surface; and
the measurement of the position comprises receiving a diffracted light of the first measurement beam from the grating.

21. An exposing method wherein a pattern is formed on an object by radiating an energy beam, the method comprising:
a process that uses a driving method according to claim 19 to drive a holding member, whereon the object is mounted, in order to form the pattern.

22. An exposing method that forms a pattern on an object by radiating an energy beam, the method comprising:
moving a first moving body, which comprises guide members that extend in the first axial direction, in the second axial direction;
moving two second moving bodies, wherein a space is formed and which are provided such that they are capable of moving independently in the first axial direction along the guide members, in the second axial direction together with the guide members by the movement of the first moving body;
mounting the object to a holding member, which is held such that is capable of moving relative to the two moving bodies at least within a plane that is parallel to the two dimensional plane and wherein a measurement surface is provided to one surface that is substantially parallel to the two dimensional surface;
measuring the position of the moving body at least within the two dimensional plane by radiating at least one first measurement beam from the arm member—which has a longitudinal direction oriented in the first axial direction, is disposed such that at least a first end part and a second end part opposes the measurement surface, and at least part of which is a solid part wherethrough light can travel—to the measurement surface disposed on the holding member along a surface that is substantially parallel to the two dimensional plane, and receiving the light of the first measurement beam from the measurement surface;
measuring a change in the shape of the arm member by radiating at least one second measurement beam from the second end part of the arm member to a detection surface provided to the first end part of the arm member via the solid part and receiving light of the second measurement beam from the detection surface; and
scanning the object with respect to the energy beam by driving the holding member in a scanning direction within the two dimensional plane based on the measurement results of the first measuring step and the second measuring step.

23. A device fabricating method comprising:
exposing an object using an exposing method according to claim 21; and developing the exposed object.
